(19) United States
(12) Patent Application Publication
(10) Pub. No.: US 2026/0164406 A1
(43) Pub. Date: Jun. 11, 2026

(54) Method for PEI and SDT Conflict Resolution

(71) Applicant: Apple Inc., Cupertino, CA (US)

(72) Inventors: Dongzhou Yang, Beijing (CN); Prince Siaw Attrams, Haslet, TX (US); Lele Cui, Beijing (CN); Gibran Ali, San Jose, CA (US); Sushant Vikram, San Diego, CA (US); Ajay Singh, San Jose, CA (US); Deepankar Bhattacharjee, San Jose, CA (US)

(21) Appl. No.: 18/971,847

(22) Filed: Dec. 6, 2024

(51) Int. Cl. H04W 68/02; H04W 76/27

(52) U.S. Cl. CPC H04W 68/02; H04W 76/27

(57) ABSTRACT

An apparatus of a user equipment (UE) configured to transmit a radio resource control (RRC) resume request to a base station using a small data transmission (SDT) preamble to initiate an SDT procedure at the UE. The UE can monitor, during the SDT procedure, a paging occasion (PO) associated with a paging early indicator (PEI). A UE can identify a plurality of fifth generation system temporary mobile subscriber identities (5G-S-TMSI) associated with the PO to enable the UE to determine when there is a matching 5G-S-TMSI of the plurality of 5G-S-TMSI that matches a 5G-S-TMSI of the UE during the SDT procedure.

### FIELD

Embodiments of the invention relate to wireless communications, including apparatuses, systems, and methods for conflict resolution between a paging early indicator procedure and a small data transfer procedure in wireless communication systems.

### DESCRIPTION OF THE RELATED ART

Wireless communication systems are used to provide various communication services such as telephone, video, data and messaging. The wireless communication systems can support communication with multiple users by sharing available system resources such as bandwidth and transmit power.

The wireless communication system may include a number of base stations (BSs) that can support communication for a number of user equipment (UEs). A BS may be referred to as a Node B, a gNB, an access point (AP), a radio head, a transmit receive point (TRP), a New Radio (NR) BS, a 5G Node B, or the like. A UE may be referred to as a wireless mobile device or cellular phone.

Telecommunication standards have been adopted to provide a common protocol to enable different UEs and BSs to communicate on a municipal, national, regional, and even global level. Wireless communication system standards and protocols can include the 3rd Generation Partnership Project (3GPP) long term evolution (LTE) (e.g., 4G) or new radio (NR) (e.g., 5G). In 3GPP radio access networks (RANs) in LTE systems, the base station can include a RAN Node such as an Evolved Universal Terrestrial Radio Access Network (E-UTRAN) Node B (also commonly denoted as evolved Node B, enhanced Node B, eNodeB, or eNB) and/or Radio Network Controller (RNC) in an E-UTRAN, which communicate with the UE. In fifth generation (5G) wireless RANs, RAN Nodes can include a 5G Node, or NR node (also referred to as a next generation Node B or g Node B (gNB)).

### BRIEF DESCRIPTION OF THE DRAWINGS

A better understanding of the present subject matter can be obtained when the following detailed description of various embodiments is considered in conjunction with the following drawings, in which:

FIG. 1A illustrates an example wireless communication system according to some embodiments.

FIG. 1B illustrates an example of a base station and an access point in communication with a user equipment (UE) device, according to some embodiments.

FIG. 2 illustrates an example block diagram of a base station, according to some embodiments.

FIG. 3 illustrates an example block diagram of a server according to some embodiments.

FIG. 4 illustrates an example block diagram of a UE according to some embodiments.

FIG. 5 illustrates an example block diagram of cellular communication circuitry, according to some embodiments.

FIG. 6 illustrates an example of a baseband processor architecture for a UE, according to some embodiments.

FIG. 7 illustrates an example block diagram of an interface of baseband circuitry according to some embodiments.

FIG. 8 illustrates an example of a control plane protocol stack in accordance with some embodiments.

FIG. 9 illustrates an example of a user plane protocol stack in accordance with some embodiments.

FIG. 10 illustrates an example of the contents of a PCCH-Config message in accordance with some embodiments.

FIG. 11 illustrates an example of a paging configuration in accordance with current 3GPP specifications where PFs are evenly distributed throughout a paging cycle, in accordance with some embodiments.

FIG. 12 illustrates an example of a PEI bit field in accordance with some embodiments.

FIG. 13 illustrates an example of a diagram of a PEI message in relation to an upcoming PO in accordance with some embodiments.

FIG. 14 illustrates an example of a diagram of potential power savings for UEs that are provided for by PEI in accordance with some embodiments.

FIG. 15 illustrates an example of a diagram of a PEI indicating upcoming POs for the first two PFs in a paging cycle in accordance with some embodiments.

FIG. 16 illustrates an example of a diagram of a frame-level offset and a symbol-level offset for a PEI with relation to the first PF in a paging cycle in accordance with some embodiments.

FIG. 17 illustrates an example of a diagram of a random access small data transfer (RA-SDT) two step procedure, in accordance with some embodiments.

FIG. 18 illustrates an example of a diagram of a random access small data transfer (RA-SDT) four step procedure, in accordance with some embodiments.

FIG. 19 illustrates an example of a configured grant small data transfer (CG-SDT) procedure in accordance with an embodiment of the present disclosure.

FIG. 20 illustrates an example of an SDT procedure that is initiated by a user equipment (UE) via a radio resource control resume request (RRCResumeRequest) message sent as an RRC information element (IE) in accordance with some embodiments.

FIG. 21 illustrates an example of a PEI procedure with downlink control information (DCI) format 2_7 in accordance with some embodiments.

FIG. 22 illustrates an example of a PEI procedure aligned with an SDT procedure in accordance with some embodiments.

FIG. 23 illustrates example of diagrams of SDT procedures and a PEI procedure with the UE configured to monitor the PO during the SDT procedure, in accordance with some embodiments.

FIG. 24 illustrates example of diagrams of SDT procedures and a PEI procedure with the UE configured to postpone the SDT procedure when paging in a PO is for a current UE, in accordance with some embodiments.

FIG. 25 illustrates an exemplary flow chart of a method of a UE determining to initiate a mobile originated SDT based on local information if there is uplink small data after receiving a PEI but before the PEI is associated with a PO in accordance with some embodiments.

FIG. 26 illustrates an exemplary flow chart of a method of a network determining to send an RRC resume message to a UE, when the UE has initiated an MO SDT or an SDT procedure is ongoing, when paging is pending for the UE, in accordance with some embodiments.

FIG. 27 illustrates an exemplary flow chart of a method of a network determining to send an RRC resume message to a UE, when the UE has initiated an MO SDT or an SDT procedure is ongoing, when a downlink buffer at the network is less than or greater than a threshold level, in accordance with some embodiments.

FIG. 28 illustrates an exemplary flow chart of a method of a network determining to send an RRC resume message to a UE, when the UE has initiated an MO SDT or an SDT procedure is ongoing, when a system information (SI) change occurs or a public warning system (PWS) notification is active, in accordance with some embodiments.

FIG. 29 illustrates an exemplary flow chart of a method of a network determining to send an RRC resume message to a UE, when the UE has initiated an MO SDT or an SDT procedure is ongoing, when a mobile terminal (MT) call is pending, in accordance with some embodiments.

FIG. 30 illustrates an exemplary flow chart of a method of a UE receiving a PO priority indication field in a downlink config common system information block (SIB) to enable the UE to perform an SDT procedure based on a PO priority in the priority indication field in accordance with some embodiments.

FIG. 31 illustrates an example of paging priority indication field information added to DownlinkConfigCommonSIB information, in accordance with some embodiments.

FIG. 32 illustrates an example of a flow chart for a method of performing a mobile originated (MO) small data transfer (SDT) at a user equipment (UE) based on local information, in accordance with some embodiments.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Terms

The following is a glossary of terms used in this disclosure:
Memory Medium or Memory—Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc. ; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.
Carrier Medium—a memory medium as described above, as well as a physical transmission medium, such as a bus, network, and/or other physical transmission medium that conveys signals such as electrical, electromagnetic, or digital signals.

Programmable Hardware Element includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.
Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.
User Equipment (UE) (or “UE Device”)—any of various types of computer systems devices which are mobile or portable and which performs wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, wearable devices (e.g., smart watch, smart glasses), PDAs, portable Internet devices, Internet of Things, music players, data storage devices, other handheld devices, unmanned aerial vehicles (UAVs) (e.g., drones), UAV controllers (UACs), and so forth. In general, the term “UE” or “UE device” can be broadly defined to encompass any electronic, computing, and/or telecommunications device (or combination of devices) which is easily transported by a user and capable of wireless communication.
Base Station—The term “Base Station” has the full breadth of its ordinary meaning, and at least includes a wireless communication station installed at a fixed location and used to communicate with UEs as part of a wireless telephone system or radio system, including but not limited Next Generation Node-Bs (gNB) in NR. A “Base Station” is a network component of a wireless network while a UE is not.
Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.
Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. 5G NR can support scalable channel bandwidths from 5 MHz to 100 MHz in Frequency Range 1 (FR1 ) and up to 400 MHz in FR2. In other radio access technologies, WLAN channels may be 22 MHz wide while Bluetooth channels may be 1 MHz wide. Other protocols and standards may include different definitions of channels. Furthermore, some standards may define and use multiple types of channels, e.g., different channels for uplink or downlink and/or different channels for different uses such as data, control information, etc.
Band—The term “band” has the full breadth of its ordinary meaning, and at least includes a section of spectrum (e.g., radio frequency spectrum) in which channels are used or set aside for the same purpose.
Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system will update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.
Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as set by the particular application.
Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.
Paging—refers to a process is a process used by a base station (gNB) to alert a specific UE that there is incoming traffic, such as a call, SMS (Short Message Service), or other data. In most cases, the paging procedure occurs when the UE is in a Radio Resource Control (RRC) idle mode. This means that the UE typically monitors for a paging message whether or not the network is sending the UE any paging messages. During the idle mode, the UE enters and stays in a sleep mode that is defined to remain in a Discontinuous Reception (DRX) cycle. The UE wakes up and monitors the Physical Downlink Control Channel (PDCCH) during a specific paging opportunity (PO) of a specific paging frame (PF) to check if there is a paging message. If the PDCCH indicates that the paging message is transmitted in the subframe, the UE demodulates the Physical Downlink Shared Channel (PDSCH) to receive the paging message that is directed to the UE.
Paging Frame (PF)—refers to specific frame within a radio frame structure used by a wireless network. It is a frame number in which messages are transmitted to alert UEs on the PDCCH. Each PF corresponds to a specific point in time within the radio frame.
Paging Occasion (PO)—refers to specific time slots, intervals or subframes in a PF during which a network sends out messages to locate and notify a particular UE of a network event. UEs wake up and listen for messages during assigned POs on the PDCCH. A UE only monitors one PO in a paging cycle. Subgroups of UEs may monitor the same PO in a paging cycle.
System Frame Number (SFN)—refers to a network-wide counter that keeps track of the overall frame number in the cellular network. It provides synchronization information for all UEs within the network.
Synchronization Signal Block (SSB)—refers to the synchronization signal and physical broadcast channel (PBCH) block that includes the primary synchronization signal (PSS), the secondary synchronization signal (SSS), the physical broadcast channel (PBCH) and the PBCH demodulation reference signal (DRMS). The SSB can be transmitted periodically. Each cell typically includes an SSB. The UE uses the information in the SSB to connect with the cell.
Secondary Synchronization Signal (SSS)—refers to periodic signals transmitted by a base station (gNB) that help UEs to synchronize with a network. SSSs are transmitted periodically within the synchronization signal block (SSB), and UEs monitor them to establish and maintain synchronization.
Paging Early Indication (PEI)—refers to a power-saving process of notifying UEs of upcoming network events that require their attention. With PEI, a UE can avoid frequent wake-ups to check for messages. Instead, the UE can rely on PEIs to determine when and if to wake up and actively listen for paging messages in upcoming POs. PEIs can be integrated with SSBs to convey early indication paging information to UEs. That is, a base station (gNB) can use the periodic SSB transmissions to carry the PEIs. This way, a UE can receive the early paging indication information while monitoring the SSBs. PEI may contain a bitmap that indicates whether a subgroup of UEs monitoring the same PO need to monitor a page or not. That is, the PEI indicates whether there is a page in the PO in the corresponding PF of the paging subgroup for a UE. When the PEI indicates a positive page, the UEs are configured to monitor the PO in the corresponding PF.
PEI configuration—refers to information that informs UEs which radio frames carry PEIs. The PEI configuration may define a frame-level offset and a symbol-level offset. A base station (gNB) may select, encode, and transmit PEI configuration information to UEs as part of a registration process.
Discontinuous Reception (DRX)—refers to a power-saving mechanism used in cellular networks, to help extend the battery life of UEs while still maintaining network connectivity. DRX works by allowing a UE to periodically sleep or turn off its radio reception for defined intervals when it's not actively receiving data. During these DRX cycles, the UE conserves power by not continuously monitoring the network for incoming messages or data. Instead, it wakes up at predefined intervals to check for any pending data or signaling. This periodic sleep-wake cycle helps reduce power consumption without losing essential network connectivity.
Extended DRX (eDRX)—refers to an extension of DRX that provides increased power savings for UEs.
Paging Group—refers to a grouping of UEs into subgroups based on various criteria, and paging opportunities can be scheduled for specific groups of UEs at different times to further optimize paging. Subgroups of UEs may monitor the same PO in a paging cycle.
Paging Configuration—refers to system information related to paging UEs that identifies one or more of: the total number of frames in a paging cycle, the number and location of PFs in the paging cycle, and the number of POs per PF. Using paging configuration information, UEs can determine which PO and PF to monitor in a paging cycle.
5G-S-TMSI—refers to a Fifth Generation System Temporary Mobile Subscriber Identity (5G-S-TMSI) that is assigned to UEs by a wireless network during a registration process. 5G-S-TMSI is the shortened form of the Globally Unique Temporary Identifier (GUTI) to enable more efficient radio signalling procedures (e.g. during Paging and Service Request) and is defined as: <5G-S-TMSI>:=<AMF Set ID><AMF Pointer><5G-TMSI>.
Small Data Transmission—A procedure used for transmission of data and/or signalling over allowed radio bearers in RRC_INACTIVE state (i.e. without the UE transitioning to RRC_CONNECTED state).

Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

The example embodiments may be further understood with reference to the following description and the related appended drawings, wherein like elements are provided with the same reference numerals. The example embodiments relate to apparatuses, systems and method for reducing energy usage by network components, e.g., base stations in wireless communication systems.

The example embodiments are described with regard to communication

between a Next Generation Node B (gNB) and a user equipment (UE). However, reference to a gNB or a UE is merely provided for illustrative purposes. The example embodiments may be utilized with any electronic component that may establish a connection to a network and is configured with the hardware, software, and/or firmware to support for reducing energy usage by network components in wireless communication systems. Therefore, the gNB or UE as described herein is used to represent any appropriate type of electronic component.

The example embodiments are also described with regard to a fifth

generation (5G) New Radio (NR) network that may configure a UE to support for reducing energy usage by network components in wireless communication systems. However, reference to a 5G NR network is merely provided for illustrative purposes. The example embodiments may be utilized with any appropriate type of network.

Throughout this description various information elements (IEs) are

referred to by specific names. It should be understood that these names are only examples and the IEs carrying the information referred to throughout this description may be referred to by other names by various entities.

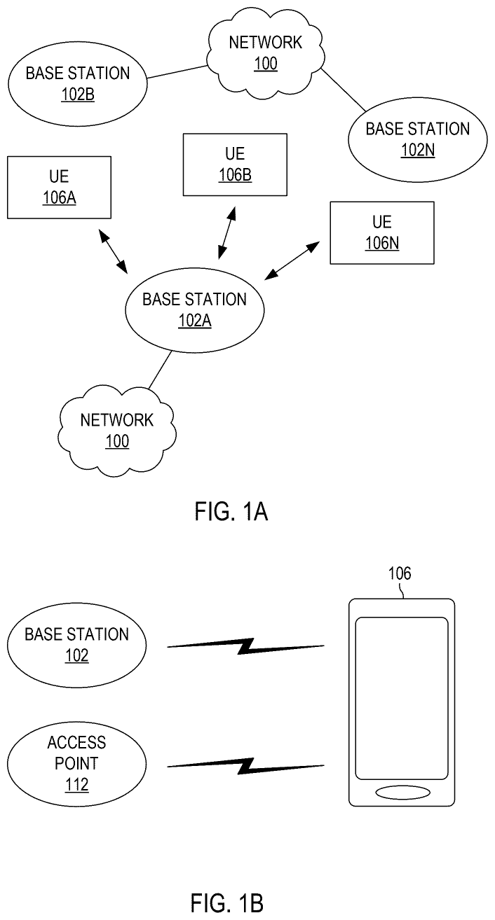

### FIGS. 1A and 1B: Communication Systems

FIG. 1A illustrates a simplified example wireless communication system, according to some embodiments. It is noted that the system of FIG. 1A is merely one example of a possible system, and that features of this disclosure may be implemented in any of various systems, as desired.

As shown, the example wireless communication system includes a base station 102A which communicates over a transmission medium with one or more user devices 106A, 106B, etc., through 106N. Each of the user devices may be referred to herein as a “user equipment” (UE). Thus, the user devices 106 are referred to as UEs or UE devices.

The base station (BS) 102A may be a base transceiver station (BTS) or cell site (a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1 xRTT, 1 xEV-DO, HRPD, eHRPD), etc. Note that if the base station 102A is implemented in the context of LTE, also referred to as the Evolved Universal Terrestrial Radio Access Network (E-UTRAN, it may alternately be referred to as an ‘eNodeB’ or ‘eNB’. Note that if the base station 102A is implemented in the context of 5G NR, it may alternately be referred to as ‘gNodeB’ or ‘gNB’.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base Station 102a and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1A, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1A might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1xRTT, 1xEV-DO, HRPD, eHRPD), etc.). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

In some embodiments, the base station 102A may select a paging configuration and a PEI configuration for UEs 106. The base station 102A may encode and transmit the paging configuration and the PEI configuration to UEs 106 as part of a registration process. Using the paging configuration, UEs 106 can determine which PO and PF to monitor in a paging cycle. Using the PEI configuration, UEs 106 can determine the radio frame that carries relevant PEI.

FIG. 1B illustrates user equipment 106 (e.g., one of the devices 106A through 106N) in communication with a base station 102 and an access point 112, according to some embodiments. The UE 106 may be a device with both cellular communication capability and non-cellular communication capability (e.g., Bluetooth, Wi-Fi, and so forth) such as a mobile phone, a hand-held device, a computer or a tablet, or virtually any type of wireless device.

The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein.

The UE 106 may include one or more antennas for communicating using one or more wireless communication protocols or technologies. In some embodiments, the UE 106 may be configured to communicate using, for example, CDMA2000 (1xRTT/1xEV-DO/HRPD/eHRPD), LTE/LTE-Advanced, or 5G NR using a single shared radio and/or GSM, LTE, LTE-Advanced, or 5G NR using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or LTE or 1xRTTor LTE or GSM), and separate radios for communicating using each of Wi-Fi and Bluetooth. Other configurations are also possible.

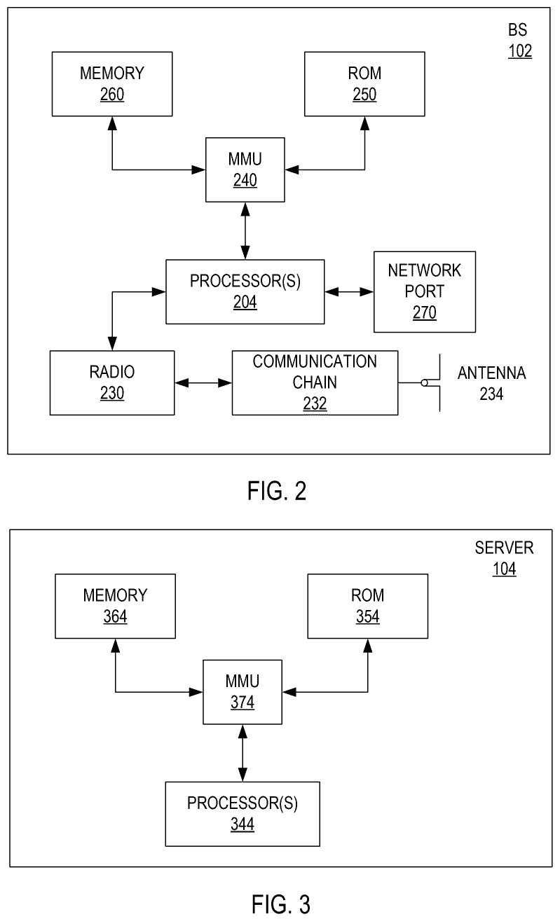

### FIG. 2: Block Diagram of a Base Station (GNB)

FIG. 2 illustrates an example block diagram of a base station 102, according to some embodiments. It is noted that the base station of FIG. 2 is merely one example of a possible base station. As shown, the base station 102 may include processor(s) 204 which may execute program instructions for the base station 102. The processor(s) 204 may also be coupled to memory management unit (MMU) 240, which may be configured to receive addresses from the processor(s) 204 and translate those addresses to locations in memory (e.g., memory 260 and read only memory (ROM) 250) or to other circuits or devices.

The base station 102 may include at least one network port 270. The network port 270 may be configured to couple to a telephone network and provide a plurality of devices, such as UE devices 106, access to the telephone network as described above in FIGS. 1 and 2.

The network port 270 (or an additional network port) may also or alternatively be configured to couple to a cellular network, e.g., a core network of a cellular service provider. The core network may provide mobility related services and/or other services to a plurality of devices, such as UE devices 106. In some cases, the network port 270 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 234, and possibly multiple antennas. The at least one antenna 234 may be configured to operate as a wireless transceiver and may be further configured to communicate with UE devices 106 via radio 230. The antenna 234 communicates with the radio 230 via communication chain 232. Communication chain 232 may be a receive chain, a transmit chain or both. The radio 230 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, LTE and Wi-Fi, LTE and UMTS, LTE and CDMA2000, UMTS and GSM, etc.).

As described further subsequently herein, the base station 102 may include hardware and software components for implementing or supporting implementation of features described herein. The processor 204 of the base station 102 may be configured to implement or support implementation of part or all of the methods described herein, e.g., by executing program instructions stored on a memory medium (e.g., a non-transitory computer-readable memory medium). Alternatively, the processor 204 may be configured as a programmable hardware element, such as an FPGA (Field Programmable Gate Array), or as an ASIC (Application Specific Integrated Circuit), or a combination thereof. Alternatively (or in addition) the processor 204 of the base station 102, in conjunction with one or more of the other components 230, 232, 234, 240, 250, 260, 270 may be configured to implement or support implementation of part or all of the features described herein.

In addition, as described herein, processor(s) 204 may be comprised of one or more processing elements. In other words, one or more processing elements may be included in processor(s) 204. Thus, processor(s) 204 may include one or more integrated circuits (ICs) that are configured to perform the functions of processor(s) 204. In addition, each integrated circuit may include circuitry (e.g., first circuitry, second circuitry, etc.) configured to perform the functions of processor(s) 204.

Further, as described herein, radio 230 may be comprised of one or more processing elements. In other words, one or more processing elements may be included in radio 230. Thus, radio 230 may include one or more integrated circuits (ICs) that are configured to perform the functions of radio 230. In addition, each integrated circuit may include circuitry (e.g., first circuitry, second circuitry, etc.) configured to perform the functions of radio 230.

In some embodiments, the base station or gNB 102, and/or processors 204 thereof, can be capable of and configured to communicate radio resource control (RRC) messages to network components, e.g., base station or gNB 102, in wireless communication systems.

### FIG. 3: Block Diagram of a Server

FIG. 3 illustrates an example block diagram of a server 104, according to some embodiments. It is noted that the server of FIG. 3 is merely one example of a possible server. As shown, the server 104 may include processor(s) 344 which may execute program instructions for the server 104. The processor(s) 344 may also be coupled to memory management unit (MMU) 374, which may be configured to receive addresses from the processor(s) 344 and translate those addresses to locations in memory (e.g., memory 364 and read only memory (ROM) 354) or to other circuits or devices.

The server 104 may be configured to provide a plurality of devices, such as base station 102, and UE devices 106 access to network functions, e.g., as further described herein.

In some embodiments, the server 104 may be part of a radio access network, such as a 5G New Radio (5G NR) radio access network. In some embodiments, the server 104 may be connected to a legacy evolved packet core (EPC) network and/or to a NR core (NRC) network.

As described herein, the server 104 may include hardware and software components for implementing or supporting implementation of features described herein. The processor 344 of the server 104 may be configured to implement or support implementation of part or all of the methods described herein, e.g., by executing program instructions stored on a memory medium (e.g., a non-transitory computer-readable memory medium). Alternatively, the processor 344 may be configured as a programmable hardware element, such as an FPGA (Field Programmable Gate Array), or as an ASIC (Application Specific Integrated Circuit), or a combination thereof. Alternatively (or in addition) the processor 344 of the server 104, in conjunction with one or more of the other components 354, 364, and/or 374 may be configured to implement or support implementation of part or all of the features described herein.

In addition, as described herein, processor(s) 344 may be comprised of one or more processing elements. In other words, one or more processing elements may be included in processor(s) 344. Thus, processor(s) 344 may include one or more integrated circuits (ICs) that are configured to perform the functions of processor(s) 344. In addition, each integrated circuit may include circuitry (e.g., first circuitry, second circuitry, etc.) configured to perform the functions of processor(s) 344.

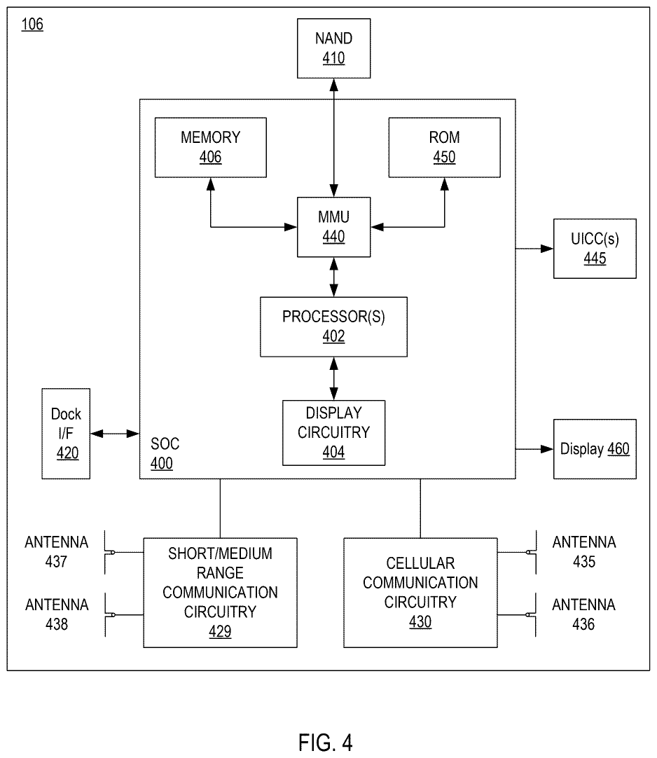

### FIG. 4: Block Diagram O F a User Equipment (UE)

FIG. 4 illustrates an example simplified block diagram of a communication device 106, according to some embodiments. It is noted that the block diagram of the communication device of FIG. 4 is only one example of a possible communication device. According to embodiments, communication device 106 may be a user equipment (UE) device, a mobile device or mobile station, a wireless device or wireless station, a desktop computer or computing device, a mobile computing device (e.g., a laptop, notebook, or portable computing device), a tablet, an unmanned aerial vehicle (UAV), a UAV controller (UAC) and/or a combination of devices, among other devices. As shown, the communication device 106 may include a set of components 400 configured to perform core functions. For example, this set of components may be implemented as a system on chip (SOC), which may include portions for various purposes. Alternatively, this set of components 400 may be implemented as separate components or groups of components for the various purposes. The set of components 400 may be coupled (e.g., communicatively; directly or indirectly) to various other circuits of the communication device 106.

For example, the communication device 106 may include various types of memory (e.g., including NAND flash 410), an input/output interface such as connector I/F 420 (e.g., for connecting to a computer system; dock; charging station; input devices, such as a microphone, camera, keyboard; output devices, such as speakers; etc.), the display 460, which may be integrated with or external to the communication device 106, and cellular communication circuitry 430 such as for 5G NR, LTE, GSM, etc., and short to medium range wireless communication circuitry 429 (e.g., Bluetooth™ and WLAN circuitry). In some embodiments, communication device 106 may include wired communication circuitry (not shown), such as a network interface card, e.g., for Ethernet.

The cellular communication circuitry 430 may couple (e.g., communicatively; directly or indirectly) to one or more antennas, such as antennas 435 and 436 as shown. The short to medium range wireless communication circuitry 429 may also couple (e.g., communicatively; directly or indirectly) to one or more antennas, such as antennas 437 and 438 as shown. Alternatively, the short to medium range wireless communication circuitry 429 may couple (e.g., communicatively; directly or indirectly) to the antennas 435 and 436 in addition to, or instead of, coupling (e.g., communicatively; directly or indirectly) to the antennas 437 and 438. The short to medium range wireless communication circuitry 429 and/or cellular communication circuitry 430 may include multiple receive chains and/or multiple transmit chains for receiving and/or transmitting multiple spatial streams, such as in a multiple-input multiple output (MIMO) configuration.

In some embodiments, as further described below, cellular communication circuitry 430 may include dedicated receive chains (including and/or coupled to, e.g., communicatively; directly or indirectly. dedicated processors and/or radios) for multiple RATs (e.g., a first receive chain for LTE and a second receive chain for 5G NR). In addition, in some embodiments, cellular communication circuitry 430 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The communication device 106 may also include and/or be configured for use with one or more user interface elements. The user interface elements may include any of various elements, such as display 460 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 445 that include SIM (Subscriber Identity Module) functionality, such as one or more UICC(s) (Universal Integrated Circuit Card(s)) cards 445. Note that the term “SIM” or “SIM entity” is intended to include any of various types of SIM implementations or SIM functionality, such as the one or more UICC(s) cards 445, one or more eUICCs, one or more eSIMs, either removable or embedded, etc. In some embodiments, the UE 106 may include at least two SIMs. Each SIM may execute one or more SIM applications and/or otherwise implement SIM functionality. Thus, each SIM may be a single smart card that may be embedded, e.g., may be soldered onto a circuit board in the UE 106, or each SIM 410 may be implemented as a removable smart card. Thus, the SIM(s) may be one or more removable smart cards (such as UICC cards, which are sometimes referred to as “SIM cards”), and/or the SIMs 410 may be one or more embedded cards (such as embedded UICCs (eUICCs), which are sometimes referred to as “eSIMs” or “eSIM cards”). In some embodiments (such as when the SIM(s) include an eUICC), one or more of the SIM(s) may implement embedded SIM (eSIM) functionality; in such an embodiment, a single one of the SIM(s) may execute multiple SIM applications. Each of the SIMs may include components such as a processor and/or a memory; instructions for performing SIM/eSIM functionality may be stored in the memory and executed by the processor. In some embodiments, the UE 106 may include a combination of removable smart cards and fixed/non-removable smart cards (such as one or more eUICC cards that implement eSIM functionality), as desired. For example, the UE 106 may comprise two embedded SIMs, two removable SIMs, or a combination of one embedded SIMs and one removable SIMs. Various other SIM configurations are also contemplated.

As noted above, in some embodiments, the UE 106 may include two or more SIMs. The inclusion of two or more SIMs in the UE 106 may allow the UE 106 to support two different telephone numbers and may allow the UE 106 to communicate on corresponding two or more respective networks. For example, a first SIM may support a first RAT such as LTE, and a second SIM 410 support a second RAT such as 5G NR. Other implementations and RATs are of course possible. In some embodiments, when the UE 106 comprises two SIMs, the UE 106 may support Dual SIM Dual Active (DSDA) functionality. The DSDA functionality may allow the UE 106 to be simultaneously connected to two networks (and use two different RATs) at the same time, or to simultaneously maintain two connections supported by two different SIMs using the same or different RATs on the same or different networks. The DSDA functionality may also allow the UE 106 to simultaneously receive voice calls or data traffic on either phone number. In certain embodiments the voice call may be a packet switched communication. In other words, the voice call may be received using voice over LTE (VoLTE) technology and/or voice over NR (VoNR) technology. In some embodiments, the UE 106 may support Dual SIM Dual Standby (DSDS) functionality. The DSDS functionality may allow either of the two SIMs in the UE 106 to be on standby waiting for a voice call and/or data connection. In DSDS, when a call/data is established on one SIM, the other SIM is no longer active. In some embodiments, DSDx functionality (either DSDA or DSDS functionality) may be implemented with a single SIM (e.g., a eUICC) that executes multiple SIM applications for different carriers and/or RATs.

As shown, the SOC 400 may include processor(s) 402, which may execute program instructions for the communication device 106 and display circuitry 404, which may perform graphics processing and provide display signals to the display 460. The processor(s) 402 may also be coupled to memory management unit (MMU) 440, which may be configured to receive addresses from the processor(s) 402 and translate those addresses to locations in memory (e.g., memory 406, read only memory (ROM) 450, NAND flash memory 410) and/or to other circuits or devices, such as the display circuitry 404, short to medium range wireless communication circuitry 429, cellular communication circuitry 430, connector I/F 420, and/or display 460. The MMU 440 may be configured to perform memory protection and page table translation or set up. In some embodiments, the MMU 440 may be included as a portion of the processor(s) 402.

As described herein, the communication device 106 may include hardware and software components for implementing the above features for a communication device 106 to communicate a scheduling profile for power savings to a network. The processor 402 of the communication device 106 may be configured to implement part or all of the features described herein, e.g., by executing program instructions stored on a memory medium (e.g., a non-transitory computer-readable memory medium). Alternatively (or in addition), processor 402 may be configured as a programmable hardware element, such as an FPGA (Field Programmable Gate Array), or as an ASIC (Application Specific Integrated Circuit). Alternatively (or in addition) the processor 402 of the communication device 106, in conjunction with one or more of the other components 400, 404, 406, 410, 420, 429, 430, 440, 445, 450, 460 may be configured to implement part or all of the features described herein.

In addition, as described herein, processor 402 may include one or more processing elements. Thus, processor 402 may include one or more integrated circuits (ICs) that are configured to perform the functions of processor 402. In addition, each integrated circuit may include circuitry (e.g., first circuitry, second circuitry, etc.) configured to perform the functions of processor(s) 402.

Further, as described herein, cellular communication circuitry 430 and short to medium range wireless communication circuitry 429 may each include one or more processing elements. In other words, one or more processing elements may be included in cellular communication circuitry 430 and, similarly, one or more processing elements may be included in short to medium range wireless communication circuitry 429. Thus, cellular communication circuitry 430 may include one or more integrated circuits (ICs) that are configured to perform the functions of cellular communication circuitry 430. In addition, each integrated circuit may include circuitry (e.g., first circuitry, second circuitry, etc.) configured to perform the functions of cellular communication circuitry 430. Similarly, the short to medium range wireless communication circuitry 429 may include one or more ICs that are configured to perform the functions of short to medium range wireless communication circuitry 429. In addition, each integrated circuit may include circuitry (e.g., first circuitry, second circuitry, etc.) configured to perform the functions of short to medium range wireless communication circuitry 429.

In some embodiments, the UE 106 and/or the processors 402 thereof can be configured to and/or capable of communicating an RRC resume message to the network 100 via a base station, such as a gNB 102 when the UE has initiated a mobile originated small data transfer (MO SDT) with an SDT preamble or an SDT procedure is ongoing.

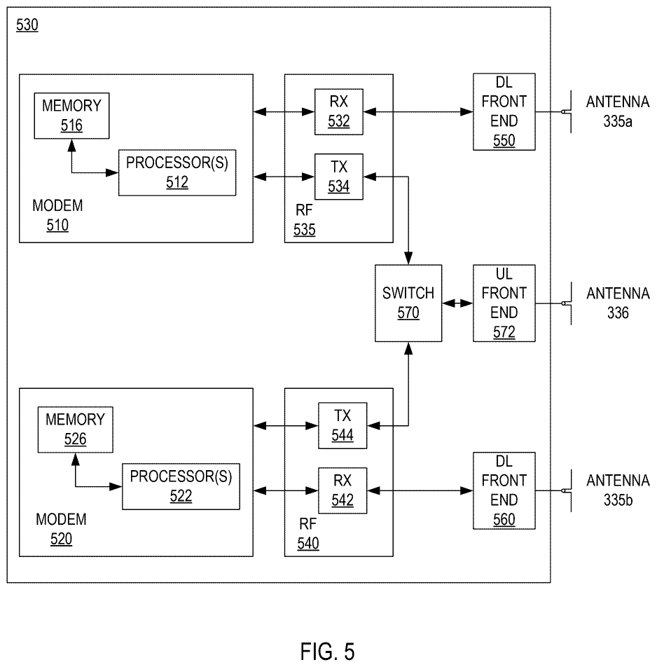

### FIG. 5: Block Diagram of Cellular Communication Circuitry

FIG. 5 illustrates an example simplified block diagram of cellular communication circuitry, according to some embodiments. It is noted that the block diagram of the cellular communication circuitry of FIG. 5 is only one example of a possible cellular communication circuit. According to embodiments, cellular communication circuitry 530, which may be cellular communication circuitry 430, may be included in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 530 may couple (e.g., communicatively; directly or indirectly) to one or more antennas, such as antennas 435a-b and 436 as shown (in FIG. 4). In some embodiments, cellular communication circuitry 530 may include dedicated receive chains (including and/or coupled to, e.g., communicatively; directly or indirectly. dedicated processors and/or radios) for multiple RATs (e.g., a first receive chain for LTE and a second receive chain for 5G NR). For example, as shown in FIG. 5, cellular communication circuitry 530 may include a modem 510 and a modem 520. Modem 510 may be configured for communications according to a first RAT, e.g., such as LTE or LTE-A, and modem 520 may be configured for communications according to a second RAT, e.g., such as 5G NR.

As shown, modem 510 may include one or more processors 512 and a memory 516 in communication with processors 512. Modem 510 may be in communication with a radio frequency (RF) front end 535. RF front end 535 may include circuitry for transmitting and receiving radio signals. For example, RF front end 535 may include receive circuitry (RX) 532 and transmit circuitry (TX) 534. In some embodiments, receive circuitry 532 may be in communication with downlink (DL) front end 550, which may include circuitry for receiving radio signals via antenna 335a.

Similarly, modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 335b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 530 receives instructions to transmit according to the first RAT (e.g., as supported via modem 510), switch 570 may be switched to a first state that allows modem 510 to transmit signals according to the first RAT (e.g., via a transmit chain that includes transmit circuitry 534 and UL front end 572). Similarly, when cellular communication circuitry 530 receives instructions to transmit according to the second RAT (e.g., as supported via modem 520), switch 570 may be switched to a second state that allows modem 520 to transmit signals according to the second RAT (e.g., via a transmit chain that includes transmit circuitry 544 and UL front end 572).

As described herein, the modem 510 may include hardware and software components for implementing the above features or for time division multiplexing UL data for NSA NR operations, as well as the various other techniques described herein. The processors 512 may be configured to implement part or all of the features described herein, e.g., by executing program instructions stored on a memory medium (e.g., a non-transitory computer-readable memory medium). Alternatively (or in addition), processor 512 may be configured as a programmable hardware element, such as an FPGA (Field Programmable Gate Array), or as an ASIC (Application Specific Integrated Circuit). Alternatively (or in addition) the processor 512, in conjunction with one or more of the other components 530, 532, 534, 535, 550, 570, 572, 335a, 335b, and 336 may be configured to implement part or all of the features described herein.

In addition, as described herein, processors 512 may include one or more processing elements. Thus, processors 512 may include one or more integrated circuits (ICs) that are configured to perform the functions of processors 512. In addition, each integrated circuit may include circuitry (e.g., first circuitry, second circuitry, etc.) configured to perform the functions of processors 512.

The processors 522 may be configured to implement part or all of the features described herein, e.g., by executing program instructions stored on a memory medium (e.g., a non-transitory computer-readable memory medium). Alternatively (or in addition), processor 522 may be configured as a programmable hardware element, such as an FPGA (Field Programmable Gate Array), or as an ASIC (Application Specific Integrated Circuit). Alternatively (or in addition) the processor 522, in conjunction with one or more of the other components 540, 542, 544, 550, 570, 572, 335a, 335b, and 336 may be configured to implement part or all of the features described herein.

In addition, as described herein, processors 522 may include one or more processing elements. Thus, processors 522 may include one or more integrated circuits (ICs) that are configured to perform the functions of processors 522. In addition, each integrated circuit may include circuitry (e.g., first circuitry, second circuitry, etc.) configured to perform the functions of processors 522.

In some embodiments, the processors 512, 522 can be configured for communicating an RRC resume message as further described herein.

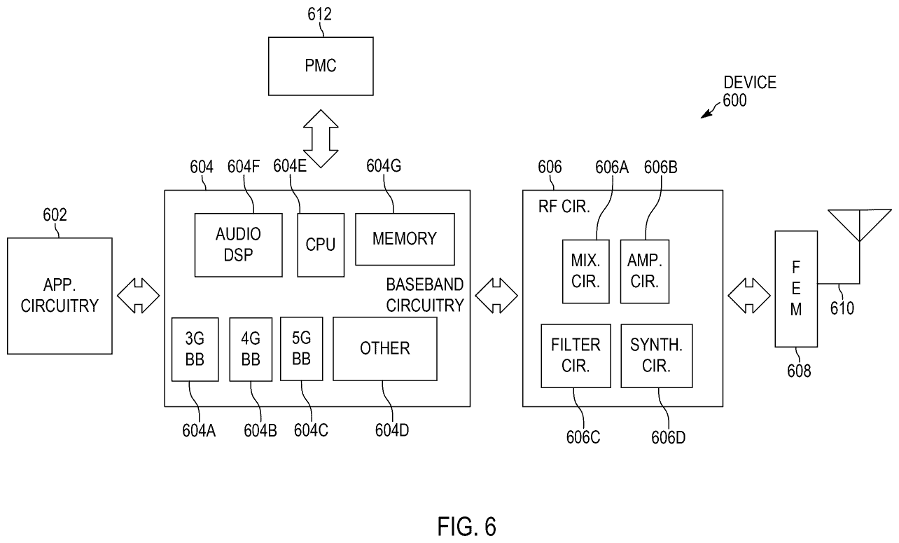

### FIG. 6: Block Diagram of a Baseband Processor Architecture for a UE

FIG. 6 illustrates example components of a device 600 in accordance with some embodiments. It is noted that the device of FIG. 6 is merely one example of a possible system, and that features of this disclosure may be implemented in any of various UEs, as desired.

In some embodiments, the device 600 may include application circuitry 602, baseband circuitry 604, Radio Frequency (RF) circuitry 606, front-end module (FEM) circuitry 608, one or more antennas 610, and power management circuitry (PMC) 612 coupled together at least as shown. The components of the illustrated device 600 may be included in a UE 106 or a RAN node 102A. In some embodiments, the device 600 may include less elements (e.g., a RAN node may not utilize application circuitry 602, and instead include a processor/controller to process IP data received from an EPC). In some embodiments, the device 600 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry 602 may include one or more application processors. For example, the application circuitry 602 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 600. In some embodiments, processors of application circuitry 602 may process IP data packets received from an EPC.

The baseband circuitry 604 may include circuitry such as, but not limited to, one or more single-core or multi-core processors. The baseband circuitry 604 may include one or more baseband processors or control logic to process baseband signals received from a receive signal path of the RF circuitry 606 and to generate baseband signals for a transmit signal path of the RF circuitry 606. Baseband processing circuity 604 may interface with the application circuitry 602 for generation and processing of the baseband signals and for controlling operations of the RF circuitry 606. For example, in some embodiments, the baseband circuitry 604 may include a third generation (3G) baseband processor 604A, a fourth generation (4G) baseband processor 604B, a fifth generation (5G) baseband processor 604C, or other baseband processor(s) 604D for other existing generations, generations in development or to be developed in the future (e.g., second generation (2G), sixth generation (6G), etc.). The baseband circuitry 604 (e.g., one or more of baseband processors 604A-D) may handle various radio control functions that enable communication with one or more radio networks via the RF circuitry 606. In other embodiments, some or all of the functionality of baseband processors 604A-D may be included in modules stored in the memory 604G and executed via a Central Processing Unit (CPU) 604E. The radio control functions may include, but are not limited to, signal modulation/demodulation, encoding/decoding, radio frequency shifting, etc. In some embodiments, modulation/demodulation circuitry of the baseband circuitry 604 may include Fast-Fourier Transform (FFT), precoding, or constellation mapping/demapping functionality. In some embodiments, encoding/decoding circuitry of the baseband circuitry 604 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 604 may include one or more audio digital signal processor(s) (DSP) 604F. The audio DSP(s) 604F may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 604 and the application circuitry 602 may be implemented together such as, for example, on a system on a chip (SOC).

In some embodiments, the baseband circuitry 604 may provide for communication compatible with one or more radio technologies. For example, in some embodiments, the baseband circuitry 604 may support communication with an evolved universal terrestrial radio access network (EUTRAN) or other wireless metropolitan area networks (WMAN), a wireless local area network (WLAN), a wireless personal area network (WPAN). Embodiments in which the baseband circuitry 604 is configured to support radio communications of more than one wireless protocol may be referred to as multi-mode baseband circuitry.

RF circuitry 606 may enable communication with wireless networks using modulated electromagnetic radiation through a non-solid medium. In various embodiments, the RF circuitry 606 may include switches, filters, amplifiers, etc. to facilitate the communication with the wireless network. RF circuitry 606 may include a receive signal path which may include circuitry to down-convert RF signals received from the FEM circuitry 608 and provide baseband signals to the baseband circuitry 604. RF circuitry 606 may also include a transmit signal path which may include circuitry to up-convert baseband signals provided by the baseband circuitry 604 and provide RF output signals to the FEM circuitry 608 for transmission.

In some embodiments, the receive signal path of the RF circuitry 606 may include mixer circuitry 606a, amplifier circuitry 606b and filter circuitry 606c. In some embodiments, the transmit signal path of the RF circuitry 606 may include filter circuitry 606c and mixer circuitry 606a. RF circuitry 606 may also include synthesizer circuitry 606d for synthesizing a frequency for use by the mixer circuitry 606a of the receive signal path and the transmit signal path. In some embodiments, the mixer circuitry 606a of the receive signal path may be configured to down-convert RF signals received from the FEM circuitry 608 based on the synthesized frequency provided by synthesizer circuitry 606d. The amplifier circuitry 606b may be configured to amplify the down-converted signals and the filter circuitry 606c may be a low-pass filter (LPF) or band-pass filter (BPF) configured to remove unwanted signals from the down-converted signals to generate output baseband signals. Output baseband signals may be provided to the baseband circuitry 604 for further processing. In some embodiments, the output baseband signals may be zero-frequency baseband signals, although this is not a necessity. In some embodiments, mixer circuitry 606a of the receive signal path may comprise passive mixers, although the scope of the embodiments is not limited in this respect.

In some embodiments, the mixer circuitry 606a of the transmit signal path may be configured to up-convert input baseband signals based on the synthesized frequency provided by the synthesizer circuitry 606d to generate RF output signals for the FEM circuitry 608. The baseband signals may be provided by the baseband circuitry 604 and may be filtered by filter circuitry 606c.

In some embodiments, the mixer circuitry 606a of the receive signal path and the mixer circuitry 606a of the transmit signal path may include two or more mixers and may be arranged for quadrature downconversion and upconversion, respectively. In some embodiments, the mixer circuitry 606a of the receive signal path and the mixer circuitry 606a of the transmit signal path may include two or more mixers and may be arranged for image rejection (e.g., Hartley image rejection). In some embodiments, the mixer circuitry 606a of the receive signal path and the mixer circuitry 606a may be arranged for direct downconversion and direct upconversion, respectively. In some embodiments, the mixer circuitry 606a of the receive signal path and the mixer circuitry 606a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 606 may include analog-to-digital converter (ADC) and digital-to-analog converter (DAC) circuitry and the baseband circuitry 604 may include a digital baseband interface to communicate with the RF circuitry 606.

In some dual-mode embodiments, a separate radio IC circuitry may be provided for processing signals for each spectrum, although the scope of the embodiments is not limited in this respect.

In some embodiments, the synthesizer circuitry 606d may be a fractional-N synthesizer or a fractional N/N+1 synthesizer, although the scope of the embodiments is not limited in this respect as other types of frequency synthesizers may be suitable. For example, synthesizer circuitry 606d may be a delta-sigma synthesizer, a frequency multiplier, or a synthesizer comprising a phase-locked loop with a frequency divider.

The synthesizer circuitry 606d may be configured to synthesize an output frequency for use by the mixer circuitry 606a of the RF circuitry 606 based on a frequency input and a divider control input. In some embodiments, the synthesizer circuitry 606d may be a fractional N/N+1 synthesizer.

In some embodiments, frequency input may be provided by a voltage controlled oscillator (VCO), although that is not a necessity. Divider control input may be provided by either the baseband circuitry 604 or the applications processor 602 depending on the desired output frequency. In some embodiments, a divider control input (e.g., N) may be determined from a look-up table based on a channel indicated by the applications processor 602.

Synthesizer circuitry 606d of the RF circuitry 606 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 606d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 606 may include an IQ/polar converter.

FEM circuitry 608 may include a receive signal path which may include circuitry configured to operate on RF signals received from one or more antennas 610, amplify the received signals and provide the amplified versions of the received signals to the RF circuitry 606 for further processing. FEM circuitry 608 may also include a transmit signal path which may include circuitry configured to amplify signals for transmission provided by the RF circuitry 606 for transmission by one or more of the one or more antennas 610. In various embodiments, the amplification through the transmit or receive signal paths may be done solely in the RF circuitry 606, solely in the FEM 608, or in both the RF circuitry 606 and the FEM 608.

In some embodiments, the FEM circuitry 608 may include a TX/RX switch to switch between transmit mode and receive mode operation. The FEM circuitry may include a receive signal path and a transmit signal path. The receive signal path of the FEM circuitry may include an LNA to amplify received RF signals and provide the amplified received RF signals as an output (e.g., to the RF circuitry 606). The transmit signal path of the FEM circuitry 608 may include a power amplifier (PA) to amplify input RF signals (e.g., provided by RF circuitry 606), and one or more filters to generate RF signals for subsequent transmission (e.g., by one or more of the one or more antennas 610).

In some embodiments, the PMC 612 may manage power provided to the baseband circuitry 604. In particular, the PMC 612 may control power-source selection, voltage scaling, battery charging, or DC-to-DC conversion. The PMC 612 may often be included when the device 600 is capable of being powered by a battery, for example, when the device is included in a UE. The PMC 612 may increase the power conversion efficiency while providing desirable implementation size and heat dissipation characteristics.

While FIG. 6 shows the PMC 612 coupled only with the baseband circuitry 604, in other embodiments the PMC 612 may be additionally or alternatively coupled with, and perform similar power management operations for, other components such as, but not limited to, application circuitry 602, RF circuitry 606, or FEM 608.

In some embodiments, the PMC 612 may control, or otherwise be part of, various power saving mechanisms of the device 600. For example, if the device 600 is in a radio resource control_Connected (RRC_Connected) state, where it is still connected to the RAN node as it expects to receive traffic shortly, then it may enter a state known as Discontinuous Reception Mode (DRX) after a period of inactivity. During this state, the device 600 may power down for brief intervals of time and thus save power.

If there is no data traffic activity for an extended period of time, then the device 600 may transition off to an RRC_Idle state, where it disconnects from the network and does not perform operations such as channel quality feedback, handover, etc. The device 600 goes into a very low power state and it performs paging where, again, it periodically wakes up to listen to the network and then powers down at least portions of the device again. The device 600 may not receive data in this state. In order to receive data, it will transition back to an RRC_Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Processors of the application circuitry 602 and processors of the baseband circuitry 604 may be used to execute elements of one or more instances of a protocol stack. For example, processors of the baseband circuitry 604, alone or in combination, may be used for encoding radio resource control messages. Accordingly, the baseband circuitry 604 can be used to encode a message for transmission between a UE and a gNB, or decode a message received between a UE and a gNB. For example, the baseband circuitry 604 can be used to encode, at the UE, an RRC resume message even if the UE has initiated an MO SDT with an SDT preamble or an SDT procedure is ongoing. These examples are not intended to be limiting. The baseband circuitry can be used as previously described.

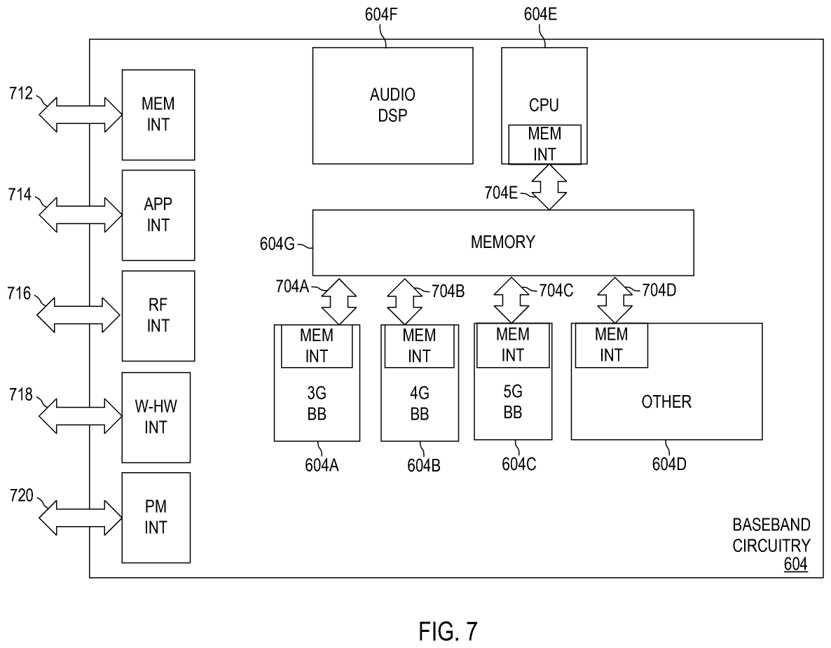

### FIG. 7: Block Diagram of an Interface of Baseband Circuitry

FIG. 7 illustrates example interfaces of baseband circuitry in accordance with some embodiments. It is noted that the baseband circuitry of FIG. 7 is merely one example of a possible circuitry, and that features of this disclosure may be implemented in any of various systems, as desired.

As discussed above, the baseband circuitry 604 of FIG. 6 may comprise processors 604A-604E and a memory 604G utilized by said processors. Each of the processors 604A-604E may include a memory interface, 704A-704E, respectively, to send/receive data to/from the memory 604G.

The baseband circuitry 604 may further include one or more interfaces to communicatively couple to other circuitries/devices, such as a memory interface 712 (e.g., an interface to send/receive data to/from memory external to the baseband circuitry 604), an application circuitry interface 714 (e.g., an interface to send/receive data to/from the application circuitry 602 of FIG. 6), an RF circuitry interface 716 (e.g., an interface to send/receive data to/from RF circuitry 606 of FIG. 6), a wireless hardware connectivity interface 718 (e.g., an interface to send/receive data to/from Near Field Communication (NFC) components, Bluetooth® components (e.g., Bluetooth® Low Energy), Wi-Fi® components, and other communication components), and a power management interface 720 (e.g., an interface to send/receive power or control signals to/from the PMC 612.

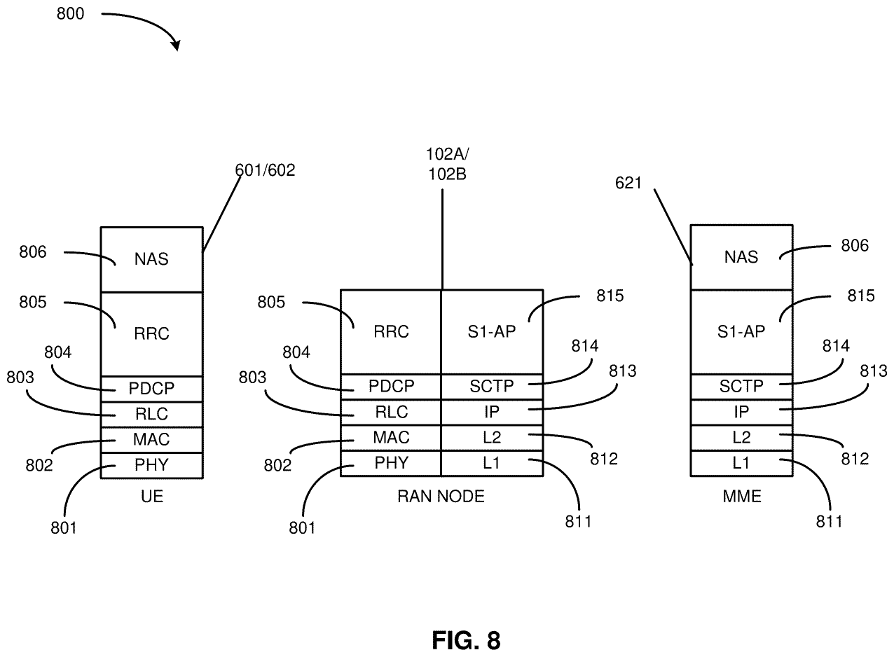

### FIG. 8: Control Plane Protocol Stack

FIG. 8 is an illustration of a control plane protocol stack in accordance with some embodiments. In this embodiment, a control plane 800 is shown as a communications protocol stack between the UE 106a (or alternatively, the UE 106b), the RAN node 102A (or alternatively, the RAN node 102B), and the mobility management entity (MME) 621.

The PHY layer 801 may transmit or receive information used by the MAC layer 802 over one or more air interfaces. The PHY layer 801 may further perform link adaptation or adaptive modulation and coding (AMC), power control, cell search (e.g., for initial synchronization and handover purposes), and other measurements used by higher layers, such as the RRC layer 805. The PHY layer 801 may still further perform error detection on the transport channels, forward error correction (FEC) coding/decoding of the transport channels, modulation/demodulation of physical channels, interleaving, rate matching, mapping onto physical channels, and Multiple Input Multiple Output (MIMO) antenna processing.

The MAC layer 802 may perform mapping between logical channels and transport channels, multiplexing of MAC service data units (SDUs) from one or more logical channels onto transport blocks (TB) to be delivered to PHY via transport channels, de-multiplexing MAC SDUs to one or more logical channels from transport blocks (TB) delivered from the PHY via transport channels, multiplexing MAC SDUs onto TBs, scheduling information reporting, error correction through hybrid automatic repeat request (HARQ), and logical channel prioritization.

The RLC layer 803 may operate in a plurality of modes of operation, including: Transparent Mode (TM), Unacknowledged Mode (UM), and Acknowledged Mode (AM). The RLC layer 803 may execute transfer of upper layer protocol data units (PDUs), error correction through automatic repeat request (ARQ) for AM data transfers, and concatenation, segmentation and reassembly of RLC SDUs for UM and AM data transfers. The RLC layer 803 may also execute re-segmentation of RLC data PDUs for AM data transfers, reorder RLC data PDUs for UM and AM data transfers, detect duplicate data for UM and AM data transfers, discard RLC SDUs for UM and AM data transfers, detect protocol errors for AM data transfers, and perform RLC re-establishment.

The PDCP layer 804 may execute header compression and decompression of IP data, maintain PDCP Sequence Numbers (SNs), perform in-sequence delivery of upper layer PDUs at re-establishment of lower layers, eliminate duplicates of lower layer SDUs at re-establishment of lower layers for radio bearers mapped on RLC AM, cipher and decipher control plane data, perform integrity protection and integrity verification of control plane data, control timer-based discard of data, and perform security operations (e.g., ciphering, deciphering, integrity protection, integrity verification, etc.).

The main services and functions of the RRC layer 805 may include broadcast of system information (e.g., included in Master Information Blocks (MIBs) or System Information Blocks (SIBs) related to the non-access stratum (NAS)), broadcast of system information related to the access stratum (AS), paging, establishment, maintenance and release of an RRC connection between the UE and E-UTRAN (e.g., RRC connection paging, RRC connection establishment, RRC connection modification, and RRC connection release), establishment, configuration, maintenance and release of point to point Radio Bearers, security functions including key management, inter radio access technology (RAT) mobility, and measurement configuration for UE measurement reporting. Said MIBs and SIBs may comprise one or more information elements (IEs), which may each comprise individual data fields or data structures.

The UE 601 and the RAN node 102A may utilize a Uu interface (e.g., an LTE-Uu interface) to exchange control plane data via a protocol stack comprising the PHY layer 801, the MAC layer 802, the RLC layer 803, the PDCP layer 804, and the RRC layer 805.

The non-access stratum (NAS) protocols 806 form the highest stratum of the control plane between the UE 601 and the MME 621. The NAS protocols 806 support the mobility of the UE 601 and the session management procedures to establish and maintain IP connectivity between the UE 601 and the P-GW 623.

The S1 Application Protocol (S1-AP) layer 815 may support the functions of the S1 interface and comprise Elementary Procedures (EPs). An EP is a unit of interaction between the RAN node 102A and the CN 1020. The S1-AP layer services may comprise two groups: UE-associated services and non UE-associated services. These services perform functions including, but not limited to: E-UTRAN Radio Access Bearer (E-RAB) management, UE capability indication, mobility, NAS signaling transport, RAN Information Management (RIM), and configuration transfer.

The Stream Control Transmission Protocol (SCTP) layer (alternatively referred to as the SCTP/IP layer) 814 may ensure reliable delivery of signaling messages between the RAN node 102A and the MME 621 based, in part, on the IP protocol, supported by the IP layer 813. The L2 layer 812 and the L1 layer 811 may refer to communication links (e.g., wired or wireless) used by the RAN node and the MME to exchange information.

The RAN node 102A and the MME 621 may utilize an S1-MME interface to exchange control plane data via a protocol stack comprising the L1 layer 811, the L2 layer 812, the IP layer 813, the SCTP layer 814, and the S1-AP layer 815.

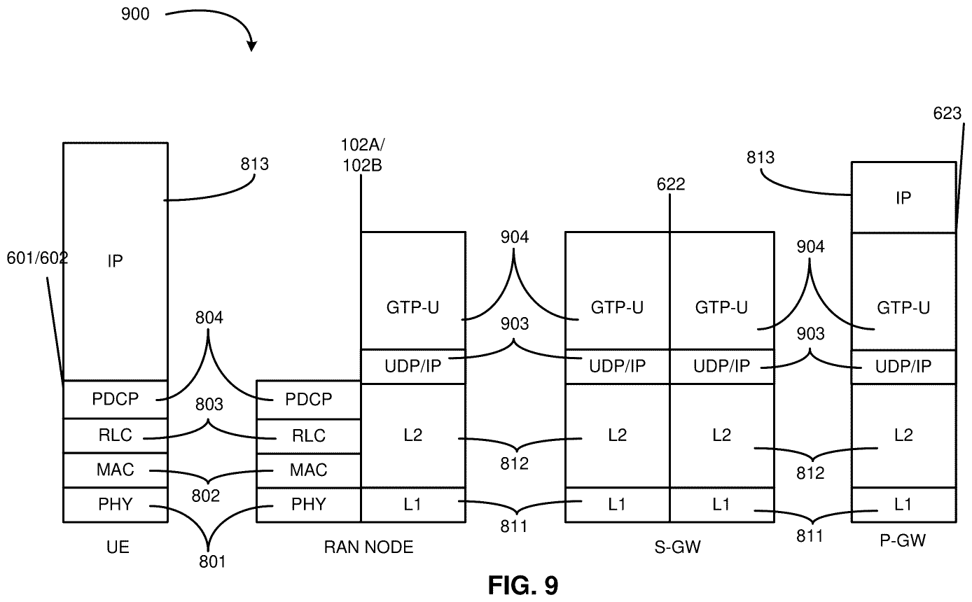

### FIG. 9: User Plane Protocol Stack

FIG. 9 is an illustration of an example of a user plane protocol stack in accordance with some embodiments. In this embodiment, a user plane 900 is shown as a communications protocol stack between the UE 106A (or alternatively, the UE 106B or 106N), the RAN node 102A (or alternatively, the RAN node 102B), the S-GW 622, and the P-GW 623. The user plane 900 may utilize at least some of the same protocol layers as the control plane 800. For example, the UE 601 and the RAN node 102A may utilize a Uu interface (e.g., an LTE-Uu interface) to exchange user plane data via a protocol stack comprising the PHY layer 801, the MAC layer 802, the RLC layer 803, the PDCP layer 804.

The General Packet Radio Service (GPRS) Tunneling Protocol for the user plane (GTP-U) layer 904 may be used for carrying user data within the GPRS core network and between the radio access network and the core network. The user data transported can be packets in any of IPv4, IPv6, or PPP formats, for example. The UDP and IP security (UDP/IP) layer 903 may provide checksums for data integrity, port numbers for addressing different functions at the source and destination, and encryption and authentication on the selected data flows. The RAN node 102A and the S-GW 622 may utilize an S1-U interface to exchange user plane data via a protocol stack comprising the L1 layer 811, the L2 layer 812, the UDP/IP layer 903, and the GTP-U layer 904. The S-GW 622 and the P-GW 623 may utilize an S5/S8a interface to exchange user plane data via a protocol stack comprising the L1 layer 811, the L2 layer 812, the UDP/IP layer 903, and the GTP-U layer 904. As discussed above with respect to FIG. 8, NAS protocols support the mobility of the UE 106 and the session management procedures to establish and maintain IP 913 connectivity between the UE 106 and the P-GW 623.

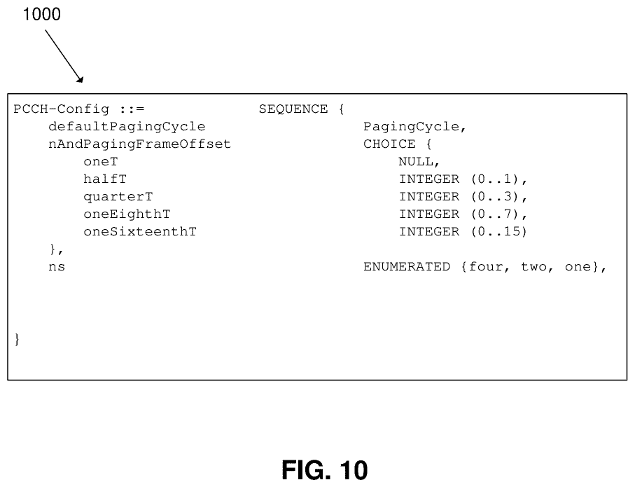

### FIGS. 10-16: Current PF/PO and PEI Configurations

The PF/PO and PEI configurations set forth in current 3GPP specifications (Release 17) provide power-saving mechanisms for UEs. These power-saving mechanisms include the use of Discontinuous Reception (DRX) and Paging Early Indication (PEI). Below, DRX will be explained first followed by PEI.

DRX reduces power consumption and conserves battery power for UEs by limiting their active time during paging cycles. A DRX cycle has a defined length measured in milliseconds and is conceptually divided into a plurality of frames. Each of the frames may have a predefined length, such as 10 milliseconds. The frames in a DRX cycle are numbered using a network-wide counter known as the System Frame Number (SFN). A subgroup of frames within the plurality of frames are selected as Paging Frames (PF). A PF is a frame number in which messages are transmitted to alert UEs of any incoming events, calls, or messages. Under current 3GPP specifications, PFs are evenly distributed throughout a paging cycle.

The use of multiple PFs in a paging cycle relieves network congestion. In particular, each UE is configured to monitor only one specific PF in a DRX cycle. A UE is assigned to its PF based upon a unique number associated with the UE referred to as “5G-S-TMSI.” Under the Third Generation Partnership Project (3GPP) Technical Specification (TS), “5G-S-TMSI” stands for “Fifth Generation Secondary Temporary Mobile Subscriber Identity” and is a temporary identifier used to uniquely identify a UE within a wireless network. Due to the use of the unique temporary identifier with a modulus operator, UEs can be scheduled to monitor different PFs or the same PF in a paging cycle. Ideally, UEs are evenly distributed amongst the PFs for improved network performance.

Each PF is further subdivided into subframes or time slots known as Paging Opportunities (POs). Each PO may have a predefined length, such as 1 millisecond. POs within a PF are numbered with an index for referencing purposes. Each UE is configured to monitor a specific PO within a specific PF based on the 5G-S-TMSI associated with the UE. Thus, UEs can be scheduled to monitor different or the same POs within their assigned PF. Because UEs can be scheduled to monitor the same PO and PF, UEs may be grouped together in a paging subgroup based on various criteria to further optimize paging.

Under Release 17-3GPP TS 38.304 § 7.1 V 17.9.0 (2024-07), the SFN of a PF for a specific UE is determined by:

$$( SFN + PF\_offset ) mod T = ( T div N ) * ( UE\_ID mod N )$$

where
SFN=system frame number;
PF_offset=an offset assigned to each UE by the network;
T=a paging cycle, such as a DRX cycle;
N=number of total paging frames in T; and
UE_ID=a Fifth Generation System Temporary Mobile Subscriber Identity (5G-S-TMSI) mod 4096 for extended Discontinuous Reception (eDRX), else 5G-S-TMSI mod 1024.

An index (i_s) indicating the subframe of the PO within a PF for a specific UE is determined by:

$$i\_s = floor ( UE\_ID / N ) mod Ns$$

where
i_s=an index of a subframe,
N=number of total paging frames in T,
Ns=number of paging occasions per PF, and
UE_ID=a Fifth Generation System Temporary Mobile Subscriber Identity (5G-S-TMSI) mod 4096 for extended Discontinuous Reception (eDRX), else 5G-S-TMSI mod 1024.

In the above, the values of T, N, and Ns are defined by network paging configurations selected by a base station (gNB) and are encoded and sent to UEs as part of a registration process. A default value of T under current 3GPP specifications is 128 frames, or 1280 milliseconds. Current 3GPP specifications define N as one of T, T/2, T/4, T/8, and T/16. Thus, valid values of N for T=128 are 128, 64, 32, 16 and 8. Current 3GPP specifications define Ns as one of 4, 2, or 1.

FIG. 10 provides an example illustration of ANSI common code (ANSI-C code) for a paging control channel configuration (PCCH-Config). As shown in FIG. 10, base stations (gNBs) provide paging configuration information to UEs as part of a logical paging control channel configuration (PCCH-Config) message 1000 under current 3GPP specifications (Release 17-3GPP TS 38.304 § 7.1 V 17.9.0 (2024-07)). As can be observed, this paging configuration defines the length of the default paging cycle (T), the number and spacing of PFs in the default paging cycle (N), and the number of paging opportunities POs per PF (Ns).

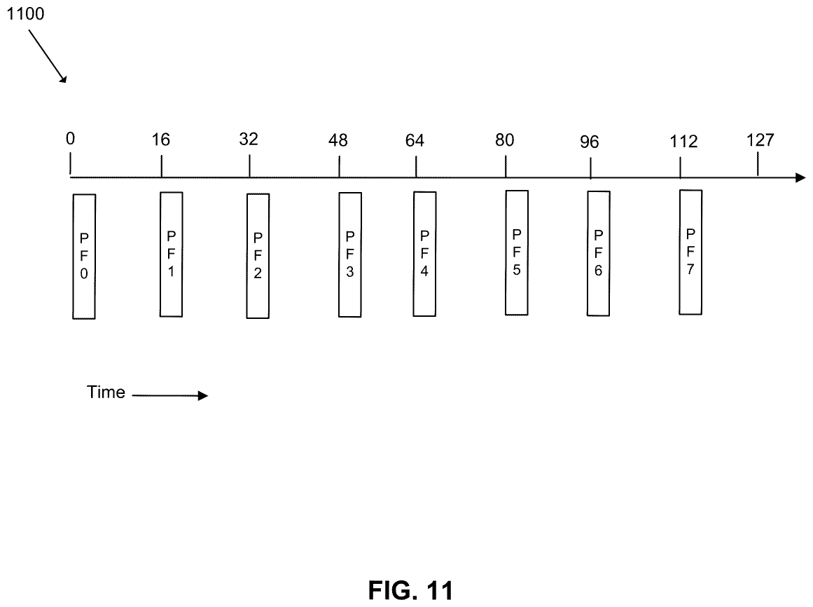

In FIG. 11, there is shown an example diagram 1100 of a paging configuration pursuant to current 3GPP specifications, where T=128, N=T/16, and PF_offset=0. When paging cycle is configured as T=128, the paging cycle has 128 frames indexed 0-127. As can be observed, there are 8 PFs (PF 0-PF7) that are uniformly distributed throughout the paging cycle. As explained above, the use of DRX configures each UE to monitor just one of the POs within one of the PFs per paging cycle.

Paging Early Indication (PEI) was introduced in 3GPP Release 17 (Release 17-3GPP TS 38.304 § 7.1 V 17.9.0 (2024-07)). PEI provides increased efficiency and power-savings for UEs. Using PEI messaging, a base station (gNB) provides early notice as to whether UEs have to monitor their upcoming POs in the paging cycle. If a UE need not monitor its upcoming PO, the UE can skip monitoring and enter a low-power state. The power saving potential of PEI resides in the reduction of a UE's active time monitoring POs and, as a consequence, increased sleep time, e.g., idle/inactive mode.

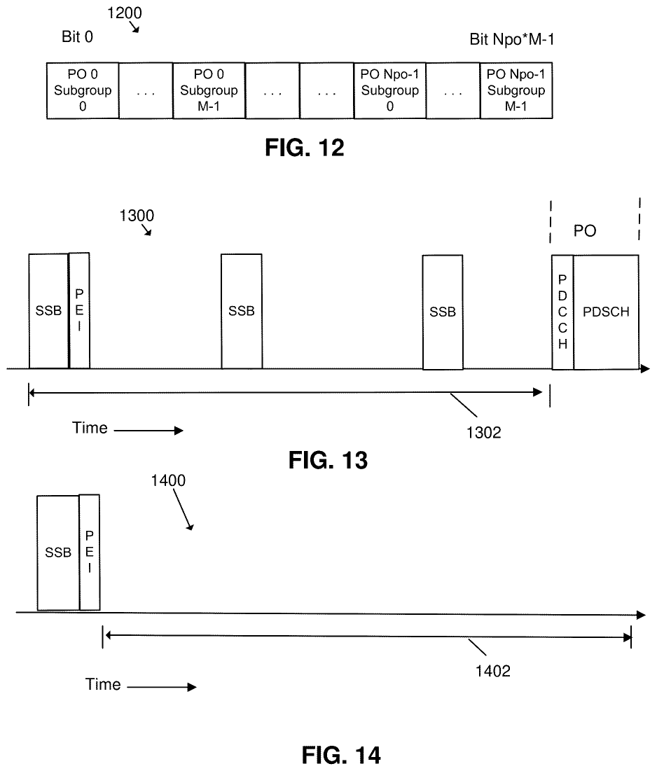

PEIs can be signaled via Downlink Control Information (DCI). However, in current 3GPP specifications DCI Format 2-7 only allows up to 8 POs, up to 2 PFs (Ns=4), and up to 8 subgroups per PO. As shown in FIG. 12, the bitmap length of a PEI field 1200 under current 3GPP specifications is Npo*M bits, where Npo is the number of POs (max 8) and M is the number of UE subgroups (max 8) associated with each PO. A UE monitors the PEI bitmap to determine whether or not it is part of a subgroup that needs to monitor an upcoming PO.

In 3GPP Release 17, PEI information is initiated by the network via DCI format 2_7, which is used for notifying the paging early indication and a tracking reference signal (TRS) availability indication for one or more UEs. The PEI configuration is provided in system information (SI). A UE in an RRC_IDLE or RRC_INACTIVE state supporting PEI can monitor PEI using the PEI parameters in the SI. The PEI indicates the subgroup that the UE belongs to in order to monitor its associated PO for paging, SI change indication, and public warning system (PWS) notification.

As shown in FIG. 13, under current 3GPP specifications, an example diagram 1300 shows how a UE can be notified by a PEI whether the UE needs to monitor and decode a PDCCH message in an upcoming PO. The PEI is sent as part of an SSB. A UE needs to be in an active state to monitor a synchronization time period 1302 in order to prepare to monitor the PO. As shown in an example diagram 1400 in FIG. 14, in the event that a UE need not monitor the PO, the UE can become inactive for a time period 1402. This inactive time period 1402 provides power saving to the UE by reducing the number of components in the receive chain that are actively powered.

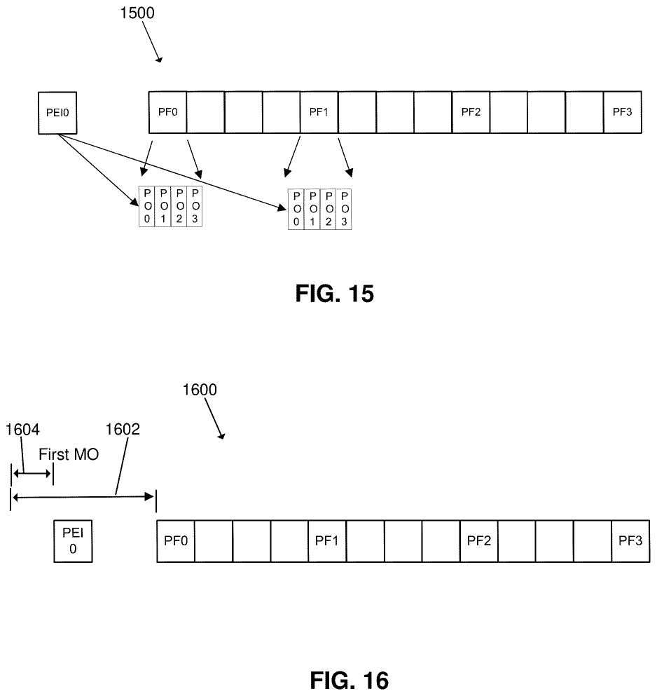

As shown in FIG. 15, an example diagram 1500 shows that, under current 3GPP specifications, each PEI can indicate up to 8 POs and up to 2 PFs. As shown in FIG. 16, a diagram 1600 shows that, under current 3GPP specifications, that a first PEI-monitoring occasion (MO) for a PEI is determined by a frame-level offset 1604 and a symbol-level offset. The frame-level offset 1604 provides the location of the reference frame with respect to the start of the first PF (PF0). The symbol-level offset 1604 provides the location of the first MO with respect to the start of the reference frame. The frame-level offset 1604 and the symbol-level offset 1606 can be provided to UEs as part of PEI configuration message during a registration process.

As explained in reference to FIGS. 10-16, above, the use of DRX and PEI as allowed for in current 3GPP specifications provide power-saving mechanisms for UEs. An additional power-saving mechanism in 3GPP is the use of small data transmissions (SDT). Throughout the history of mobile phone development, each new generation allowed for faster, more broadband data transmission. However, in the development of 5G, it was noted that some types of wireless devices are designed to communicate small amounts of data. In contrast to the high bandwidth video streaming and networked video games that are associated with modern cellular infrastructure, some devise, referred to as internet of things (IoT) devices are designed to communicate small amounts of data. These IoT devices are often wireless sensors that may be connected to thousands of different things. Everything from farming, infrastructure, industrial processes, and homes can include sensors that can measure changes in time, temperatures, directions, vibrations, velocity, flows, and so forth. They may be used to measure fertilizer concentrations in farm soil, forces on bridge buttresses, temperatures on roadways or in steel making facilities, the contents of a refrigerator, the flow of electricity, water, or gas, or the charge on a car battery. In order for these wireless sensors to function for years, they are designed to be very power efficient. The devices may send data once an hour, once a week, or once a month depending on their use.

### Small Data Transmission (SDT) in 3GPP

As the development of wireless communications standards, such as 3GPP 3G, 4G, and long term evolution (LTE) advanced, the amount of data used to connect a wireless device (e.g. user equipment) to the network (e.g. base station) increased. In typical 3GPP LTE and 5G communication standards, there may be more data communicated by an IoT device to connect with a cellular base station than the IoT device is designed to communicate during its periodic transmission. The amount of data used to connect to a network can substantially decrease the lifetime of a wireless IoT device by doubling or tripling the amount of energy used to communicate periodic data.

To reduce the amount of data used to connect an IoT device to a base station, a new class of communication was created. A small data transmission (SDT) was designed to significantly reduce the amount of data needed to connect to and communicate with a base station, while still maintaining security in the cellular communication network.

SDT provides a procedure which allows data and/or signaling transmission while the IoT device remains in an inactive state without transitioning to a connected state, such as a radio resource control (RRC) connected state. SDT is enabled on a radio bearer basis. SDT can be initiated by a UE when an amount of UL data that awaits transmission across all radio bearers, for which SDT is enabled, is less than a threshold level. Otherwise the normal data transmission scheme is used.

SDT is enabled on a radio bearer basis and can be initiated either by the UE in case of mobile originated (MO) SDT or by the network in case of mobile terminated (MT) SDT. MO-SDT is initiated by the UE only if less than a configured amount of UL data awaits transmission across all radio bearers for which SDT is enabled. MT-SDT can be initiated by the network with an indication to the UE in a paging message when DL data awaits transmission for radio bearers configured for SDT. The network can enable MO-SDT, MT-SDT, or both in a cell.

The 3GPP Release 17 specifies that a mobile originated (MO) SDT procedure that the UE may transmit data or signaling without transitioning to an RRC connected mode. Small data is able to be communicated out at low latency without data radio bearer (DRB) activation. Power can be saved at the UE via a quick connection to the network followed by a release after the small data package is communicated.

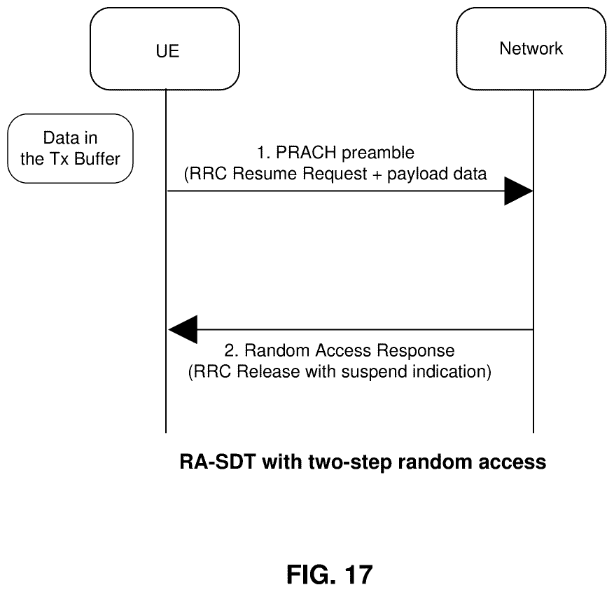

### FIGS. 17-19—SDT Using the Radom Access Procedure

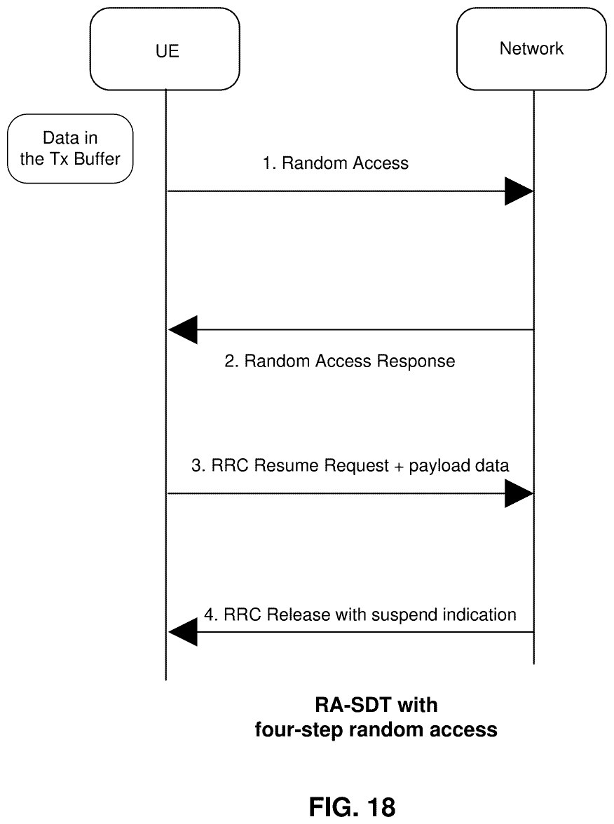

For a UE to transmit data while remaining in an inactive state (thereby conserving battery usage), two different communication schemes can be used. The first is on a random access channel (RACH) via the random access procedure. In a random access SDT (RA-SDT), the UE can use either a two-step random access procedure, as shown in FIG. 17, or a four-step random access procedure, as shown in FIG. 18. In either case, the UE can transmit the small data transfer in an uplink communication that includes a radio resource communication (RRC) resume request along with the payload data in the SDT. This occurs in step 1 in FIG. 17, and step three in FIG. 18. The use of the term “step” is not intended to imbue a certain order. The steps in FIGS. 17 and 18 may be performed in a different order than the numbering of the steps. The network (e.g. base station 102) can then communicate an RRC release with a suspend indication in a random access response in step two in FIG. 17 or in step four in FIG. 18.

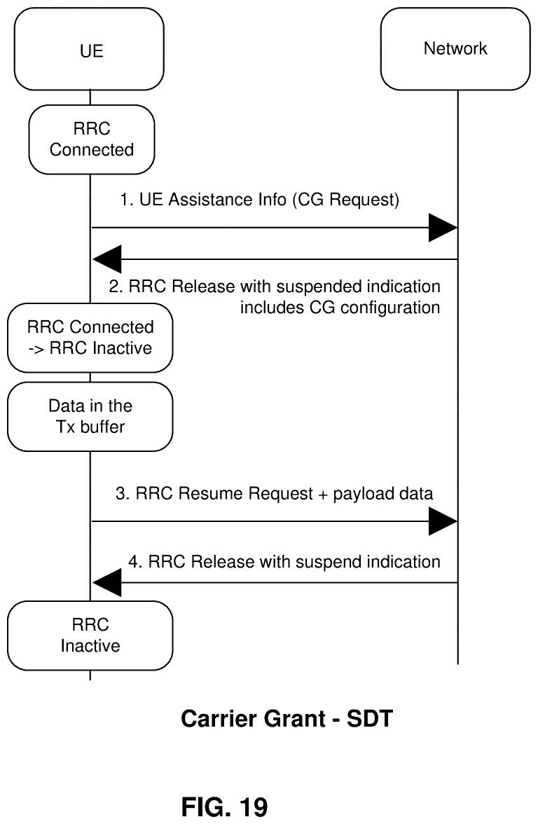

For a UE to perform SDT in a connected state, while reducing the overall amount of data used to connect to the network, a UE can perform a configured grant SDT (CG-SDT) procedure over Type 1 configured grant (CG) resources (configured via dedicated signaling in an RRCRelease message). The network can allocate a certain frequency bandwidth using a configured grant (CG) to a UE to periodically allocate radio resources for the UE. This prevents message conflicts with other IoT devices. In the CG-SDT procedure illustrated in FIG. 19, a UE that is already RRC connected with a network can send a configured grant request using UE assistance information (UAI). The UE can then operate similarly to the RA-SDT process, by sending an RRC resume request plus the SDT payload data, as shown in step three, and an RRC release with suspend indication as shown in step four.

The SDT procedure can be used by UEs that are configured for low power communication, such as an IoT device used to communicate sensor information to a cellular network. By significantly reducing the amount of data used to connect an IoT device to a cellular network, the IoT device can communicate for months or years without needing to recharge or change an internal battery power supply.

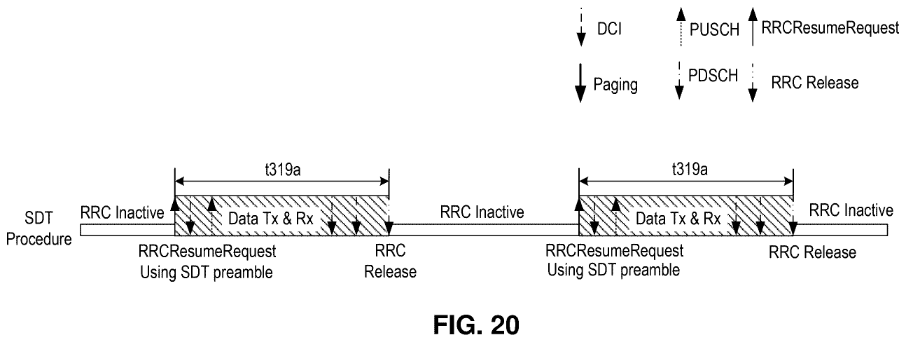

### FIGS. 20-22—Challenges of Using 3GPP Release 17 SDT With PEI

FIG. 20 provides an example illustration of an SDT procedure comprising an SDT session that is initiated by the UE via an RRCResumeRequest message sent using an SDT preamble, such as the random access preamble illustrated in FIG. 17 or 18, or the configured grant preamble illustrated in FIG. 19. The illustration shows an RRCResumeRequest message sent from the UE to a base station, followed by the UE receiving downlink control information (DCI), and sending and receiving data via a physical uplink shared channel (PUSCH) and physical downlink shared channel (PDSCH), followed by an RRC release, which puts the UE back into an RRC inactive state (e.g. a low power state).

According to the 3GPP Release 17 specification, the maximum duration that the SDT session can last is dictated by an SDT failure detection timer t319a, which has a maximum specified value of 4 seconds. Any downlink data that is pending from the network can be transmitted to the UE while the SDT procedure is ongoing.

As previously discussed, with respect to FIGS. 12 to 16, 3GPP Release 17 specifies how PEI information is used by the network to notify a UE of a paging occasion (PO). PEI parameters can be communicated to a UE via system information (SI). A UE operating in an RRC_IDLE state or an RRC_INACTIVE state that supports PEI can monitor PEI using PEI parameters that were specified in system information communicated to the UE.

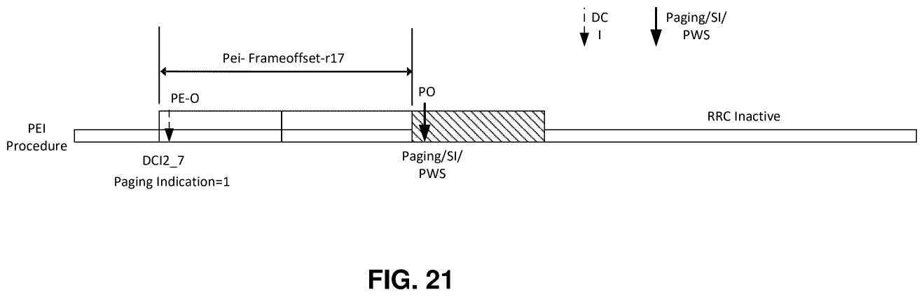

FIG. 21 provides an example illustration of a PEI procedure as specified in 3GPP Release 17. In this example, system information can include a PEI-FrameOffset time for UEs configured for Release 17. During the RRC inactive period, the UE can receive DCI format 2_7 that indicates a paging indication=1. The PEI indicates the subgroup that the UE belongs to. The UE can then monitor this subgroup and its associated PO for paging for the UE, as well as additional information, such as an SI change indication and a public warning system (PWS) notification.

Accordingly, the PEI and SDT are both 3GPP Release 17 features that enable power savings when the UE is in an idle or inactive mode. When both features are enabled by the UE and the network, power saving gains for the UE can be quite significant. However, the implementation of PEI along with SDT results in a design gap. A current limitation of the 3GPP specification is that the UE is not allowed to monitor a paging channel while the SDT procedure is ongoing.

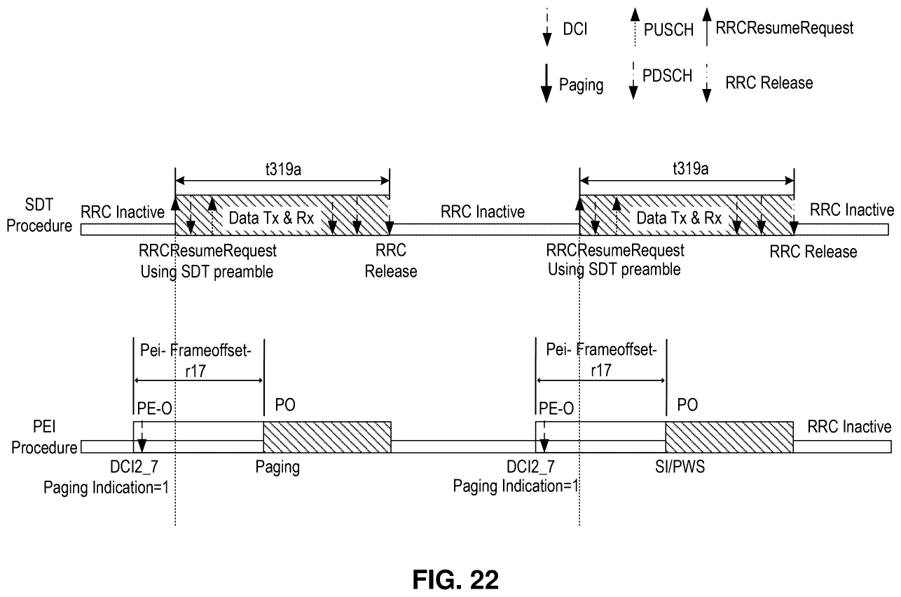

FIG. 22 provides an example illustration of the SDT procedure of FIG. 20 and the PEI procedure of FIG. 21. In this example illustration, it is shown that the PO for the UE can occur during the SDT procedure. As previously discussed, the paging opportunity can occur during the t319a timer. As illustrated in FIG. 22, the PO in the PEI procedure can occur at the same time as the SDT procedure. This means that the PO that occurs during the SDT procedure will not be monitored and decoded by a UE, such as UE 106 (FIG. 1A).

The inability to monitor for a paging channel during an SDT can result in a poor user experience and delayed reception when the PEI indication includes information for paging that enables the UE to download information for various applications, such as a mobile terminal video call, a notification regarding Facetime, and other critical indications such as a PWS indication that is received just prior to the SDT procedure.

The inability to monitor for the paging channel during the SDT can cause time sensitive and throughput sensitive services to suffer a long latency or a worse quality of service. When services such as WeChat and FaceTime are established and a long latency occurs due to the t319 a timer having a large value, of up to 4 seconds, the user experience can be severely impacted. Both the UE 106 and the network 100 can only transmit uplink data and downlink small data while the SDT procedure is ongoing. The user experience may therefore worsen due to traffic speed limitations. Voice and video applications may potentially be stuck or frozen in some cases.

In addition, the UE 106 may not receive an SI change indication or a PWS notification in time. PWS can be a critical message for users in dire situations, such as during a forest fire, earthquake, or a tsunami. When the PWS information is not received, it can put users in harm's way.

Moreover, the UE may miss receiving a voice over new radio (VoNR)/evolved packet system (EPS) fallback mobile terminal (MT) call in time due to the inability to monitor for the paging occasions during the SDT. UE VoNR/EPS Fallback MT call setup can have a long latency when the t319a timer has a large value, such as from 0.5 seconds to 4 seconds.

During an SDT procedure, the minimum value of the t319a clock is 100 milliseconds (ms) based on the 3GPP Release 17 specification. This means that there will be at least 100 ms of additional latency if a UE received a PEI but can't monitor the PEI associated PO.

The throughput during an SDT procedure can be quite low due to a low network scheduling rate and a low modulation and coding scheme (MCS). For example, an MCS value of 3 or 4 may be used during an SDT procedure, resulting in a low throughput of less than 1 megabit per second (Mbps) during an SDT procedure. As a result, throughput-sensitive applications may experience issues like voice and video freezing or stuttering because of limited data traffic speed. Although paging is intended to support these applications, the UE may not be able to enter the RRC connected state in time due to missed paging messages.

Entering an RRC connected state allows the UE to operate in a manner that is not constrained by the SDT procedure, which can be referred to as a non-SDT state or non-SDT procedure. With a higher MCS, such as an MCS of 27, and faster network scheduling, the UE can communicate in the non-SDT state at speeds that can be hundreds of times faster than data rates during the SDT procedure, such as 160 Mbps during a non-SDT procedure. These faster data rates allow throughput-sensitive applications to operate within a desired quality of service (QoS) and key performance indicators (KPI).

In order to reduce or overcome the limitations described above, the 3GPP specification can be changed to enable the UE to receive PEI paging occasions during the SDT procedure. The UE 106 and the network 100 can be configured to perform, and the 3GPP specification may be changed, in a number of different ways to accomplish enable the UE to receive PEI paging occasions during the SDT procedure or allow the UE to connect to the network (e.g. an RRC connected state) prior to the expiration of the t319a timer. These will be described in the proceeding paragraphs.

As previously discussed, a PEI may contain a bitmap that indicates whether a subgroup of UEs monitoring the same PO need to monitor a page or not. That is, the PEI indicates whether there is a page in the PO in the corresponding PF of the paging subgroup for a UE. When the PEI indicates a positive page, the UEs are configured to monitor the PO in the corresponding PF.

In accordance with some embodiments, a UE can monitor a PO associated with a PEI if the received PEI indicates the subgroup that the UE belongs to, even when an SDT procedure is ongoing. The UE can follow a typical SDT procedure, such as the SDT procedure specified in 3GPP Release 17, if the received paging is not for a UE, but only for other UEs within the same subgroup. In other words, when a 5G-S-TMSI in the PO is not matched with the UE. When the received paging is for the UE, and a 5G-S-TMSI in the PO is matched, there can be multiple solutions.

For a UE in RRC_INACTIVE state, mobile terminated (MT)-SDT is initiated by the network with an indication to the UE in the paging message when DL data awaits transmission for radio bearers configured for SDT. When MT-SDT is initiated by the UE, a resume cause indicating MT-SDT is included in the RRCResumeRequest message. It is possible for the network to enable MO-SDT or MT-SDT or both MO-SDT and MT-SDT in a cell. The MT-SDT procedure can be initiated with either a transmission over RACH or over Type 1 Configured Grant (CG) resources (configured via dedicated signaling in an RRCRelease message).

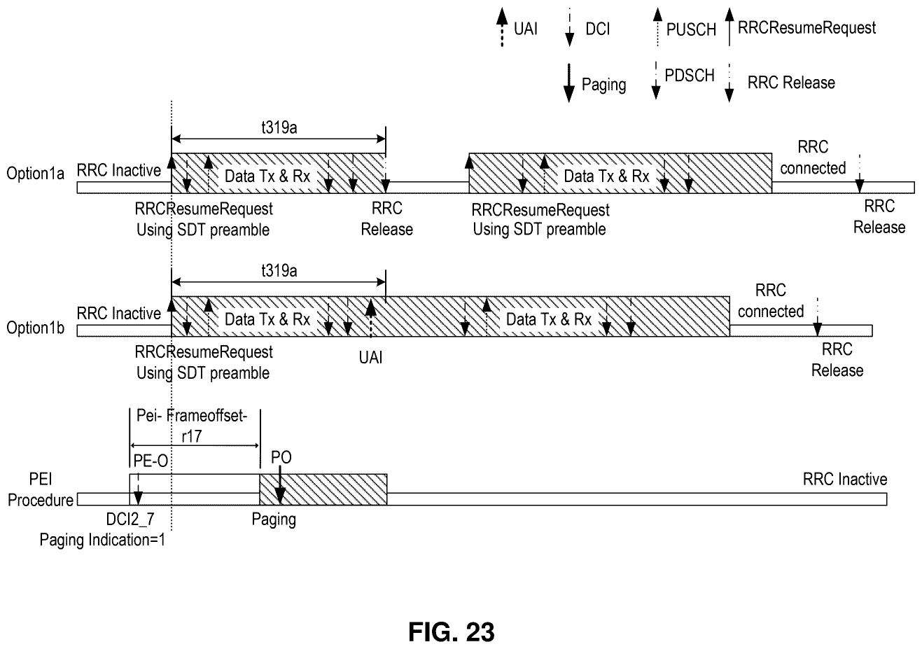

### FIG. 23—Monitoring a PO at a UE During an SDT Procedure

FIG. 23 provides an example illustration for two different solutions when the 5G-S-TMSI is matched for a UE and when the 5G-S-TMSI is not matched for the UE. The UE can monitor its PEI associated PO if the received PEI indicates the subgroup that the UE belongs to is associated with the PO even when the SDT procedure is ongoing.

In accordance with some embodiments, as shown in Option 1a of FIG. 23, a UE can initiate an RRC resume request message with a cause “MT-Access” as the response to paging in the PO when the t319a timer has expired. The RRCResumeRequest message can be sent using a SDT preamble, such as the preambles shown in FIGS. 17-19. The RRCResumeRequest message places the UE back into an RRC connected state. The UE can transmit and receive data and control information, including receiving DCI, transmit data on a PUSCH, and/or receive data on a PDSCH. The data will be communicated on data bearers that are configured for SDT communication. The UE can remain in an RRC connected state to perform SDT communication until an RRC release message is received at the UE.

In another embodiment, illustrated as Option 1b in FIG. 23, the UE can initiate transmission of a UE Assistance Information (UAI) message to provide a nonSDT-DataIndication message before the t319a timer expires. This enables data and control information to be communicated more quickly compared with Option 1A, such as DCI, to be received and data to be transmitted and received on a PUSCH and/or PDSCH. Option 1b can leverage the nonSDT procedure defined in the 3GPP Specification Release 17.

In accordance with some embodiments, an apparatus of a UE (106) is disclosed that comprises one or more processors, coupled to a memory, configured to transmit a radio resource control (RRC) resume request to a base station 102 using a small data transmission (SDT) preamble to initiate an SDT procedure at the UE. During the SDT procedure, the UE, via the one or more processors and memory, can monitor a paging occasion (PO) associated with a paging early indicator (PEI). The UE can identify, via the one or more processors and memory, a plurality of fifth generation system temporary mobile subscriber identities (5G-S-TMSI) associated with the PO to enable the UE to determine when there is a matching 5G-S-TMSI of the plurality of 5G-S-TMSI that matches a 5G-S-TMSI of the UE during the SDT procedure.

The UE 106, comprising the one or more processors, coupled to the memory, is further configured to transmit the RRC resume request to the base station 102. The UE, via the one or more processors and memory, can determine that there is the matching 5G-S-TMSI, in the plurality of 5G-S-TMSI in the PO, that matches a 5G-S-TMSI of the UE during the SDT procedure; and receive a page for the UE during the SDT procedure.

In some embodiments, the UE 106, via the one or more processors and memory, can monitor a t319a timer started at a beginning of the SDT procedure; determine that there is the matching 5G-S-TMSI, in the plurality of 5G-S-TMSI in the PO, that matches a 5G-S-TMSI of the UE before the t319 a timer expires; and receive a page for the UE before the t319a timer expires.

In some embodiments, the UE 106, via the one or more processors and memory, can send an RRC resume request message, from the UE to a base station 102, using a non-SDT preamble, with a mobile terminal access (MT-Access) cause when the t319a timer expires to place the UE in an RRC connected state.

In some embodiments, the UE 106, via the one or more processors and memory, can send a UE assistance information (UAI) message, from the UE to a base station to provide a non-SDT data indication before the t319a timer expires, to place the UE in an RRC connected state.

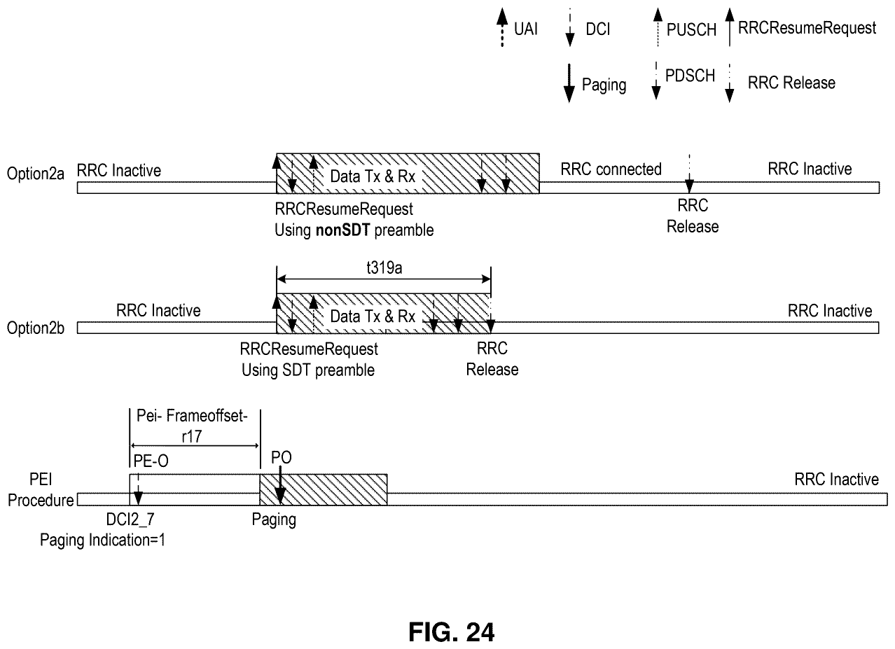

### FIG. 24—UE Postpones SDT Procedure Based on PO

In some embodiments, a UE can be configured to postpone the initiation of an SDT procedure even if all SDT conditions are fulfilled in order to receive a PO associated with a PEI. In one example embodiment, illustrated as Option 2a in FIG. 24, a UE can have data in an uplink buffer that is ready to be communicated using an SDT procedure. This can be communicated from the UE to the network via a UE assistance information (UAI) message, as shown at the dotted line in FIG. 24. However, when the PEI indicates that a PO will be received that is associated with the UE, the UE can be configured to initiate the SDT procedure but postpone performing SDT until after the PO is received and decoded and read at the UE.

After receiving the PO during the PEI procedure, the UE can initiate an RRC resume request with cause “MT-Access” if the paging indicated is for the current UE (e.g. the 5G-S-TMSI is matched). As shown, in FIG. 24, the RRCResumeRequest in Option 2a is sent using a non-SDT preamble after receiving the PO. In this example, the SDT procedure is not performed due to receiving the page for the UE. So the UE is operated in a standard (non-SDT) format to receive the data associated with the page for the UE and the SDT procedure is postponed.

In option 2b, illustrated in FIG. 24, after receiving a PO during a PEI procedure the UE can initiate the resume procedure for SDT if the paging in the PO is for other UEs within the same subgroup, but not for the UE (5G-S-TMSI is not matched). This can be done by sending an RRCResumeRequest message using the SDT preamble to resume the SDT procedure, as illustrated in FIG. 24. The UE can then perform the SDT procedure until the expiration of the t319a timer.

In some embodiments, an apparatus of a user equipment (UE) is disclosed that comprises one or more processors, coupled to a memory, configured to monitor a paging occasion (PO) associated with a paging early indicator (PEI) and identify a plurality of fifth generation system temporary mobile subscriber identities (5G-S-TMSI) associated with the PO to enable the UE to determine when there is a matching 5G-S-TMSI of the plurality of 5G-S-TMSI in the PO that matches a 5G-S-TMSI of the UE. An RRC resume request can be transmitted to a base station using a small data transmission (SDT) preamble when there is not the matching 5G-S-TMSI of the plurality of 5G-S-TMSI in the PO that matches the 5G-S-TMSI of the UE to initiate an SDT procedure at the UE after the PO. Alternatively, the RRC resume request can be transmitted with a mobile terminal access (MT-Access) cause to the base station using a non-SDT preamble to initiate an RRC connected state of the UE after the PO when there is the matching 5G-S-TMSI of the plurality of 5G-S-TMSI in the PO that matches the 5G-S-TMSI of the UE to enable the UE to: receive a page; and receive downlink data associated with the page before the SDT procedure is initiated at the UE.

In some embodiments, the one or more processors, coupled to the memory, can identify uplink information in an uplink buffer at the UE that is ready to send using SDT; determine, from the PEI, that a PO will be received from the UE; and postpone sending the RRC resume request message in a UE assistance information (UAI) message to initiate the SDT procedure until after the PO is received at the UE.

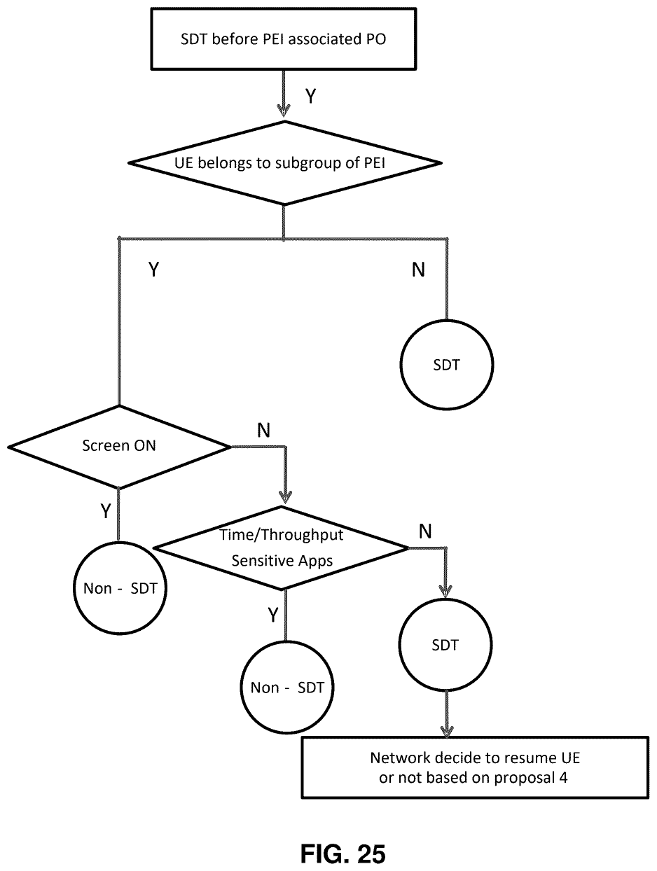

### FIG. 25—UE Determines Whether to Initiate SDT

FIG. 25 provides an example illustration of a flow chart for a UE to determine when to initiate an SDT procedure. In this example, the UE initiates an SDT procedure before a PEI procedure occurs with a PEI that is associated with a PO. The UE can determine to initiate a mobile originated (MO) SDT or not based on local information if there is uplink small data after receiving a PEI, but before the PEI is associated with a PO.

The flowchart of FIG. 25 and other flowcharts are discussed herein with reference to the splits that occur with either a YES (Y) or a NO (N). If the PEI indicates that the UE does not belong to a subgroup (N) that needs to monitor the PO, then the UE is configured to perform the SDT procedure.

If the PEI indicates that the UE does belong to a subgroup (Y) that needs to monitor the PO, then the UE determines the UE screen status. If the UE screen is on (Y), then the UE may operate in a non-SDT status, such as shown in option 2a in FIG. 24.

If the UE screen is off (N) in the example flowchart of FIG. 25, then the UE may be placed in a status to perform an SDT procedure depending on the timeliness and data throughput needs of sensitive applications operating on the UE. For example, the UE may determine whether there are potential time sensitive or data throughput sensitive applications that are actively operating on the UE. If there are time sensitive or data throughput sensitive applications operating (Y), then the UE can be configured to operate in a non-SDT status to allow the time sensitive and data throughput sensitive applications to operate at the UE. If there are not any time sensitive or data throughput sensitive applications operating on the UE (N), then the UE can be configured to perform the SDT procedure.

In some embodiments, an access point (AP) can indicate an application status for an app, such as an app's service status and the app's background/foreground status. A baseband processor, such as 604G (FIG. 6) can monitor a past data rate to determine if applications with relatively high data rates are active or not. The UE can use this information to determine if a data throughput sensitive application is operating.

A determination regarding an application's time sensitivity or data throughput sensitivity may be measured a number of different ways. For example, a quality of service (QoS) or key performance indicators (KPI) may be used. When a QoS or a KPI associated with an application is outside of s desired threshold level, then the application may be included as being time sensitive or data throughput sensitive.

In some embodiments, a method of performing a mobile originated (MO) small data transfer (SDT) at a user equipment based on local information is disclosed. The method comprises the operations of receiving a paging early indicator (PEI) at the UE, wherein the PEI is associated with a paging opportunity (PO) for the UE and the UE is a member of a subgroup of the PEI; determining that there is uplink small data at the UE after receiving the PEI and prior to the PO; and determining to perform the MO SDT at the UE based on the local information at the UE.

The operation of determining to perform the MO SDT at the UE based on the local information at the UE can further comprise: determining a screen status of the UE; and sending the uplink small data using a non-SDT procedure when the screen status of the UE is screen on; or determining the screen status is off; and identifying one or more time sensitive applications is operating on the UE; or identifying one or more data throughput sensitive applications is operating on the UE; and sending the uplink small data using an SDT procedure when no time sensitive applications are actively operating on the UE and no data throughput sensitive applications are actively operating on the UE; or sending the uplink small data using a non-SDT procedure when one or more of the time sensitive applications are operating on the UE or one or more of the data throughput sensitive applications are actively operating on the UE.

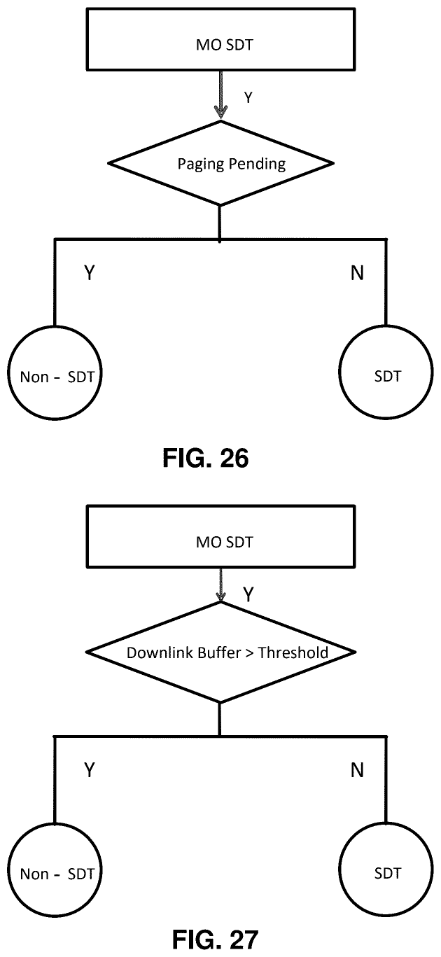

In one embodiment, the network can decide for the UE to resume operating in a non-SDT state based on the flow chart described in FIG. 26.

### FIGS. 26-29—Network Configured to Instruct UE to Perform SDT or Not

In some embodiments, the network 100 can be configured to determine that the UE 106 should resume operating in a non-SDT status (not perform an SDT procedure) or perform an SDT procedure based on local information. In the example flow chart illustrated in FIG. 26, the network can determine when the UE is performing a mobile originated SDT or an SDT procedure is ongoing at the UE. The network can check a paging status for a target UE. If there is no paging pending for the UE (N), then the UE can be configured to perform an SDT procedure. If there is a page pending (Y), then the network can send an RRC resume message for the UE to operate in a non-SDT status even if the UE has initiated a mobile originated (MO) SDT with an SDT preamble or when an SDT procedure is ongoing at the UE.

FIG. 27 illustrates an example flow chart in which the network uses a downlink buffer size to determine when an SDT procedure is performed at the UE. A threshold level for a downlink buffer size is configured at the network or specified in the 3GPP specification. When the downlink buffer is less than the threshold (N), then the UE can perform a typical SDT procedure, as shown in FIG. 27. When the downlink buffer is greater than the threshold level (Y), then the UE performing an SDT procedure, especially for a long period, can be a potential data traffic limitation. Accordingly, the network 100 can send an RRC resume message to the UE 106 even if the UE has initiated an MO SDT with SDT preamble or the SDT procedure is ongoing.

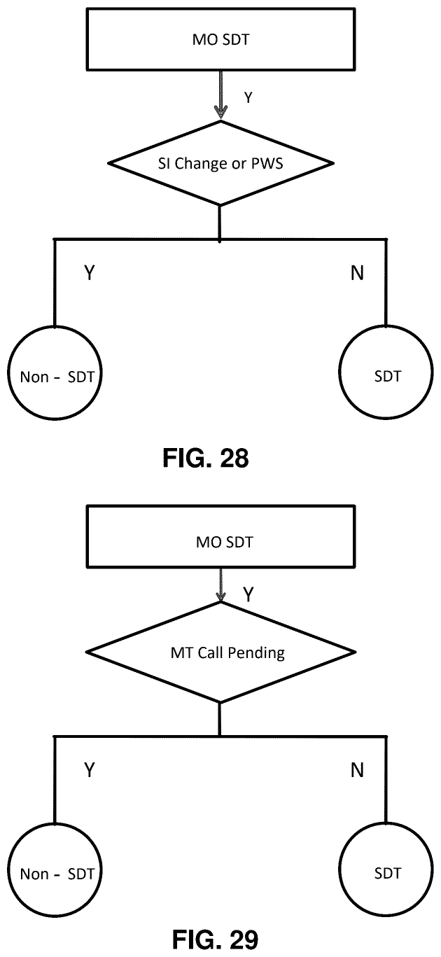

FIG. 28 illustrates an example flow chart in which the network 100 uses a change in system information or PWS to determine when an SDT procedure is performed at the UE 106. In this example, the network 100 can check to see if there has been a change in system information (SI). The network can also check a broadcast status of a PWS. When there is no change in SI or a PWS broadcast ongoing (N), then the UE can be configured to perform a typical SDT procedure as outlined in 3GPP Release 17. When there is a change in SI for the UE or there is a PWS broadcast ongoing for the UE, then the network 100 can send an RRC resume message to the UE 106 even if the UE has initiated an MO SDT with SDT preamble or the SDT procedure is ongoing.

FIG. 29 illustrates an example flow chart in which the network 100 uses a mobile terminal call ending status to determine when an SDT procedure is performed at the UE 106. In this example, the network can check a VoNR/EPS Fallback mobile terminal (MT) call status for the target UE 106. When no MT call is pending (N), then the UE can be configured to perform a typical SDT procedure as outlined in 3GPP Release 17. When there is an MT call pending for the UE, then the network 100 can send an RRC resume message to the UE 106 even if the UE has initiated an MO SDT with SDT preamble or the SDT procedure is ongoing.

In some embodiments, a method of determining, at a network, when to instruct a user equipment (UE) to transition from small data transmission (SDT) to non-SDT communication based on local information is disclosed. The method comprises the operations of: receiving, at the network, a radio resource control (RRC) resume request in an SDT preamble from the UE; or determining, at the network, that an SDT is ongoing at the UE; and sending an RRC resume to transition the UE to a non-SDT communication when local information for the UE meets a selected criteria.

In some embodiments, the method can further comprise sending the RRC resume to transition the UE to the non-SDT communication when the local information comprises a page that is pending at the network for the UE.

In some embodiments, the method can further comprise determining a downlink buffer status at the network to determine an amount of downlink buffer data for the UE; and sending an RRC resume to transition the UE to a non-SDT communication when the local information comprises that the amount of downlink buffer data for the UE is greater than a threshold level.

In some embodiments, the method can further comprise the threshold level for the amount of downlink buffer data for the UE is one or more of: a fixed amount in the specification; a variable level set by the network; a variable level based on a type of application data selected from video data, streaming data, audio data, or any other kind of data in the buffer. In one example, the fixed buffer level may be between one megabit and 10 megabits, with a 5 megabit buffer being a typical threshold level.

In some embodiments, the method can further comprise identifying, at the network, a change in system information for the UE; and sending the RRC resume to transition the UE to a non-SDT communication when the local information comprises that the network identifies the change in system information for the UE.

In some embodiments, the method can further comprise identifying, at the network, an upcoming public warning system (PWS) notification or an ongoing PWS broadcast; and sending the RRC resume to transition the UE to a non-SDT communication when the local information comprises the upcoming PWS notification or the ongoing PWS broadcast identified by the network.

In some embodiments, the method can further comprise identifying, at the network, a voice over new radio (VoNR)/evolved packet system (EPS) fallback mobile terminal (MT) call status for the UE to determine when an MT call is pending for the UE; and sending the RRC resume to transition the UE to a non-SDT communication when the MT call is pending for the UE.

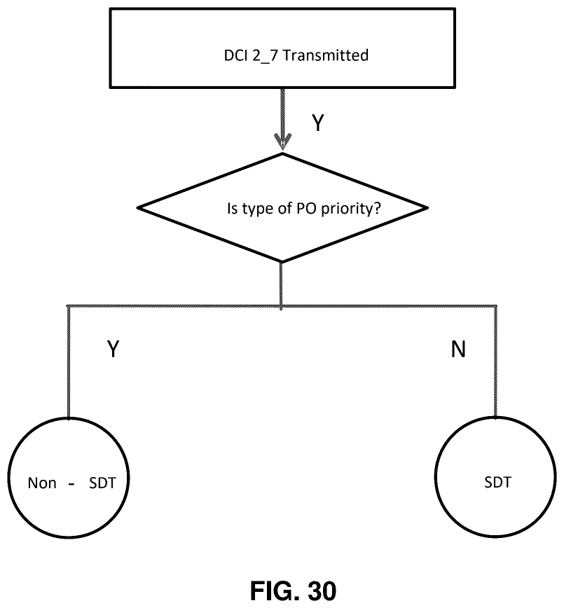

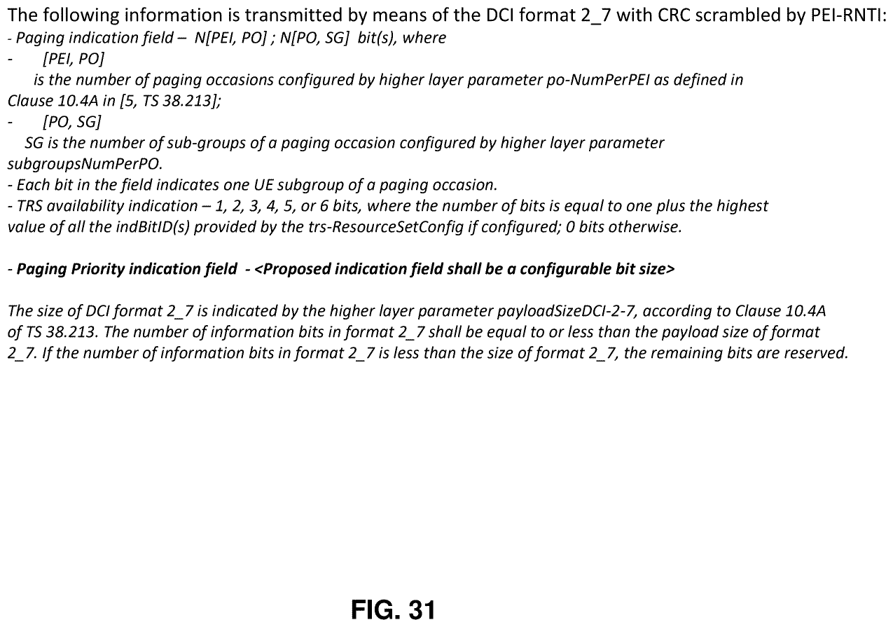

### FIGS. 30, 31—New PEI Indication Field for Type of PO

In 3GPP Technical Specification (TS) 38.213 Section 104A (Ver 17.11.0 September 2024), physical downlink control channel (PDCCH) monitoring of PEI is disclosed. In accordance with some embodiments, a new PEI indication field for a type of PO can be added to control channel signaling between the network 100 and the UE 106. In one embodiment, a type of PO priority indication field can be included in a PEI Search Space (PEISearchSpace) configured in a downlink configure common system information block (DownlinkConfigCommonSIB) and sent in downlink control information (DCI), such as in DCI Format 2_7. The information can be scrambled by a PEI-radio network temporary identifier (PEI-RNTI) on a primary cell of the master cell group (MCG).

In one example, the PO priority indication field included in the DownlinkConfigCommonSIB can be characterized by a bit value that indicates the type of PO and its priority. The indication of this bit field can help in prioritization of an SI indication sent by the network.

In one example, the PO priority indication field can include: 00 when this bit field is not configured; 01 if PO is for MT VoNR; 10 if PO is for PWS; and 11 if PO is for SI indication. This example is not intended to be limiting. Additional bits may be added to the PO priority indication field to provide additional PO types.

FIG. 30 illustrates an example flow chart in which the network 100 transmits DCI in format DCI 2_7 the UE 106 via a base station 102. In this example, the UE 106 can determine if the type of PO is a priority. In the 2 bit example, the PO can be considered a priority if the PO priority indication field is greater than 0. When the PO is not a priority (N) ((e.g. the PO priority indication is 00), then the UE can be configured to perform a typical SDT procedure as outlined in 3GPP Release 17. When PO is a priority (e.g. the PO priority indication is 01, 10, or 11), then the network 100 can send an RRC resume message to the UE 106 even if the UE has initiated an MO SDT with SDT preamble or the SDT procedure is ongoing. The paging priority indication field can have a configurable bit size. FIG. 31 provides an example illustration of the paging priority indication field information added to DownlinkConfigCommonSIB information, in accordance with some embodiments.

In some embodiments, an apparatus of a UE is disclosed that comprises one or more processors, coupled to a memory, configured to: receive a paging early indication (PEI) configuration information via system information (SI) from a network, wherein the SI includes a paging opportunity (PO) priority indication field; and receive a paging early indication (PEI) via downlink control information (DCI) in a DCI format 2_7.

In some embodiment, the one or more processors and memory are further configured to receive the PO priority indication field in a PEI search space (peiSearchSpace) in a downlink config common system information block (DownlinkConfigCommonSIB) for the DCI format 2_7 with a cyclic redundancy check (CRC) scrambled by a PEI-radio network temporary identifier (PEI-RNTI) on a primary cell of a master cell group (MCG). The PO priority indication field can comprise a bit value that indicates a type of PO and a priority of the PO, with a bit value from 1 bits to 4 bits.

In some embodiments, the bit value can comprise two bits indicating:
00 when the bit field is not configured;
01 when the PO is for a mobile terminal voice over new radio (MT VoNR);
10 when the PO is for a public warning service notification; or
11 when the PO is for a system information (SI) indication.

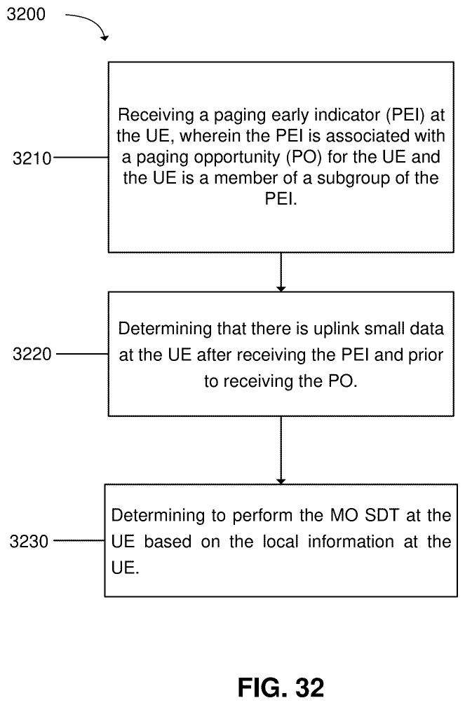

### FIG. 32: Flow Chart of Performing a Mobile Originated (MO) Small Data Transfer (SDT) at a User Equipment (UE) Based on Local Information

FIG. 32 illustrates a flow chart of a method 3200 for performing a mobile originated (MO) small data transfer (SDT) at a user equipment (UE) based on local information in accordance with some embodiments. The method 3200 shown in FIG. 32 may be used in conjunction with any of the systems, methods, or devices illustrated in the Figures, among other devices. In various embodiments, some of the method elements shown may be performed concurrently, in a different order than shown, or may be omitted. Additional method elements may also be performed as desired.

In some embodiments, the method 3200 comprises receiving a paging early indicator (PEI) at the UE, wherein the PEI is associated with a paging opportunity (PO) for the UE and the UE is a member of a subgroup of the PEI, as shown in block 3210.

The method 3200 further comprises determining that there is uplink small data at the UE after receiving the PEI and prior to receiving the PO, as shown in block 3220.

The method 3200 further comprises determining to perform the MO SDT at the UE based on the local information at the UE, as shown in block 3230.

In some embodiments, the method 3200 can further comprise determining to perform the MO SDT at the UE based on the local information at the UE can further comprise: determining a screen status of the UE as one of a status of on or a status of off; and sending the uplink small data using a non-SDT procedure when the screen status of the UE is screen on.

In some embodiments, determining to perform the MO SDT at the UE based on the local information at the UE can further comprise: determining a screen status of the UE as one of a status of on or a status of off; and sending the uplink small data using an SDT procedure when the screen status of the UE is screen off.

In some embodiments, determining to perform the MO SDT at the UE based on the local information at the UE can further comprise: identifying one or more time sensitive applications is operating on the UE; and sending the uplink small data using an SDT procedure when no time sensitive applications are actively operating on the UE.

In some embodiments, determining to perform the MO SDT at the UE based on the local information at the UE can further comprise: identifying one or more data throughput sensitive applications is operating on the UE; and sending the uplink small data using an SDT procedure when no data throughput sensitive applications are actively operating on the UE.

In some embodiments, the method 3200 can further comprise sending the uplink small data using a non-SDT procedure when one or more of the time sensitive applications are operating on the UE or one or more of the data throughput sensitive applications are actively operating on the UE.

In some embodiments, the method 3200 can further comprise sending the uplink small data using the SDT procedure when no time sensitive applications are actively operating on the UE and no data throughput sensitive applications are actively operating on the UE.

### Examples of Apparatuses, and Methods

The following examples pertain to specific technology embodiments and point out specific features, elements, or actions that can be used or otherwise combined in achieving such embodiments.

Example 1 is directed to an apparatus of a user equipment (UE) comprising: one or more processors, coupled to a memory, configured to: transmit a radio resource control (RRC) resume request to a base station using a small data transmission (SDT) preamble to initiate an SDT procedure at the UE; monitor, during the SDT procedure, a paging occasion (PO) associated with a paging early indicator (PEI); and determine, during the SDT procedure, that there is a page in the PO for the UE.

Example 2 is directed to the apparatus of Example 1, wherein the page in the PO is determined by the one or more processors configured to identify a plurality of fifth generation system temporary mobile subscriber identities (5G-S-TMSI) associated with the PO to enable the UE to determine when there is a matching 5G-S-TMSI of the plurality of 5G-S-TMSI that matches a 5G-S-TMSI of the UE during the SDT procedure.

Example 3 includes the apparatus of Example 1, wherein the one or more processors, coupled to the memory, are further configured to: transmit the RRC resume request to the base station; determine that there is a matching 5G-S-TMSI, in a plurality of 5G-S-TMSI in the PO, that matches a 5G-S-TMSI of the UE during the SDT procedure; and identify a page for the UE during the SDT procedure from the PEI and the PO.

Example 4 includes the apparatus of Example 2, wherein the one or more processors, coupled to the memory, are further configured to: monitor a t319a timer started at a beginning of the SDT procedure.

Example 5 includes the apparatus of Example 4, wherein the one or more processors, coupled to the memory, are further configured to determine that there is the matching 5G-S-TMSI, in the plurality of 5G-S-TMSI in the PO, that matches a 5G-S-TMSI of the UE before the t319 a timer expires.

Example 6 includes the apparatus of Example 5, wherein the one or more processors, coupled to the memory, are further configured to receive a page for the UE before the t319a timer expires.

Example 7 includes the apparatus of Example 5, wherein the one or more processors, coupled to the memory, are further configured to send an RRC resume request message, from the UE to a base station, using a non-SDT preamble, with a mobile terminal access (MT-Access) cause when the t319a timer expires to place the UE in an RRC connected state.

Example 8 includes the apparatus of Example 5, wherein the one or more processors, coupled to the memory, are further configured to send a UE assistance information (UAI) message, from the UE to a base station to provide a non-SDT data indication before the t319a timer expires, to place the UE in an RRC connected state.

Example 9 is directed to an apparatus of a user equipment (UE) comprising: one or more processors, coupled to a memory, configured to: monitor a paging occasion (PO) associated with a paging early indicator (PEI); identify when there is a page for the UE associated with the PO; and transmit a radio resource control (RRC) resume request message to a base station using a small data transmission (SDT) preamble when there is not a page associated with the UE to initiate an SDT procedure at the UE after the PO; or transmit the RRC resume request message with a mobile terminal access (MT-Access) cause to the base station using a non-SDT preamble to initiate an RRC connected state of the UE after the PO when there is page for the UE to enable the UE to: receive a page; and receive downlink data associated with the page before the SDT procedure is initiated at the UE.

Example 10 includes the apparatus of Example 9, wherein the one or more processors, coupled to the memory, are further configured to identify a plurality of fifth generation system temporary mobile subscriber identities (5G-S-TMSI) associated with the PO to enable the UE to determine when there is a matching 5G-S-TMSI of the plurality of 5G-S-TMSI in the PO that matches a 5G-S-TMSI of the UE to identify the page for the UE that is associated with the PO.

Example 11 includes the apparatus of Example 10, wherein the one or more processors, coupled to the memory, are further configured to transmit the RRC resume request message to the base station using the SDT preamble when there is not the matching 5G-S-TMSI of the plurality of 5G-S-TMSI in the PO that matches the 5G-S-TMSI of the UE to determine that there is not the page associated with the UE to initiate the SDT procedure at the UE after the PO.

Example 12 includes the apparatus of Example 10, wherein the one or more processors, coupled to the memory, are further configured to transmit the RRC resume request message with the MT-Access cause to the base station using the non-SDT preamble to initiate an RRC connected state of the UE after the PO when there is the matching 5G-S-TMSI of the plurality of 5G-S-TMSI in the PO that matches the 5G-S-TMSI of the UE.

Example 13 includes the apparatus of Example 9, wherein the one or more processors, coupled to the memory, are further configured to: identify uplink information in an uplink buffer at the UE that is ready to send using SDT; determine, from the PEI, that a PO will be received from the UE; and postpone sending the RRC resume request message in a UE assistance information (UAI) message to initiate the SDT procedure until after the PO is received at the UE.

Example 14 is directed to a method of performing a mobile originated (MO) small data transfer (SDT) at a user equipment (UE) based on local information, the method comprising: receiving a paging early indicator (PEI) at the UE, wherein the PEI is associated with a paging opportunity (PO) for the UE and the UE is a member of a subgroup of the PEI; determining that there is uplink small data at the UE after receiving the PEI and prior to receiving the PO; and determining to perform the MO SDT at the UE based on the local information at the UE.

Example 15 is directed to the method of Example 14, wherein determining to perform the MO SDT at the UE based on the local information at the UE further comprises: determining a screen status of the UE as one of a status of on or a status of off; and sending the uplink small data using a non-SDT procedure when the screen status of the UE is screen on.

Example 16 is directed to the method of Example 14, wherein determining to perform the MO SDT at the UE based on the local information at the UE further comprises: determining a screen status of the UE as one of a status of on or a status of off; and sending the uplink small data using an SDT procedure when the screen status of the UE is screen off.

Example 17 is directed to the method of Example 14, wherein determining to perform the MO SDT at the UE based on the local information at the UE further comprises: identifying one or more time sensitive applications is operating on the UE; and sending the uplink small data using an SDT procedure when no time sensitive applications are actively operating on the UE.

Example 18 is directed to the method of Example 17, wherein determining to perform the MO SDT at the UE based on the local information at the UE further comprises: identifying one or more data throughput sensitive applications is operating on the UE; and sending the uplink small data using an SDT procedure when no data throughput sensitive applications are actively operating on the UE.

Example 19 is directed to the method of Example 18, further comprising sending the uplink small data using a non-SDT procedure when one or more of the time sensitive applications are operating on the UE or one or more of the data throughput sensitive applications are actively operating on the UE.

Example 20 is directed to the method of Example 18, further comprising sending the uplink small data using the SDT procedure when no time sensitive applications are actively operating on the UE and no data throughput sensitive applications are actively operating on the UE.

Embodiments of the present disclosure may be realized in any of various forms. For example, some embodiments may be realized as a computer-implemented method, a computer readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., a UE 106) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. An apparatus of a user equipment (UE) comprising:
one or more processors, coupled to a memory, configured to:
transmit a radio resource control (RRC) resume request to a base station using a small data transmission (SDT) preamble to initiate an SDT procedure at the UE;
monitor, during the SDT procedure, a paging occasion (PO) associated with a paging early indicator (PEI); and
determine, during the SDT procedure, that there is a page in the PO for the UE.

2. The apparatus of claim 1, wherein the page in the PO is determined by the one or more processors configured to identify a plurality of fifth generation system temporary mobile subscriber identities (5G-S-TMSI) associated with the PO to enable the UE to determine when there is a matching 5G-S-TMSI of the plurality of 5G-S-TMSI that matches a 5G-S-TMSI of the UE during the SDT procedure.

3. The apparatus of claim 1, wherein the one or more processors, coupled to the memory, are further configured to:
transmit the RRC resume request to the base station;
determine that there is a matching 5G-S-TMSI, in a plurality of 5G-S-TMSI in the PO, that matches a 5G-S-TMSI of the UE during the SDT procedure; and
identify a page for the UE during the SDT procedure from the PEI and the PO.

4. The apparatus of claim 2, wherein the one or more processors, coupled to the memory, are further configured to:
monitor a t319a timer started at a beginning of the SDT procedure.

5. The apparatus of claim 4, wherein the one or more processors, coupled to the memory, are further configured to determine that there is the matching 5G-S-TMSI, in the plurality of 5G-S-TMSI in the PO, that matches a 5G-S-TMSI of the UE before the t319a timer expires.

6. The apparatus of claim 5, wherein the one or more processors, coupled to the memory, are further configured to receive a page for the UE before the t319a timer expires.

7. The apparatus of claim 5, wherein the one or more processors, coupled to the memory, are further configured to send an RRC resume request message, from the UE to a base station, using a non-SDT preamble, with a mobile terminal access (MT-Access) cause when the t319a timer expires to place the UE in an RRC connected state.

8. The apparatus of claim 5, wherein the one or more processors, coupled to the memory, are further configured to send a UE assistance information (UAI) message, from the UE to a base station to provide a non-SDT data indication before the t319a timer expires, to place the UE in an RRC connected state.

9. An apparatus of a user equipment (UE) comprising:
one or more processors, coupled to a memory, configured to:
monitor a paging occasion (PO) associated with a paging early indicator (PEI);
identify when there is a page for the UE associated with the PO; and
transmit a radio resource control (RRC) resume request message to a base station using a small data transmission (SDT) preamble when there is not a page associated with the UE to initiate an SDT procedure at the UE after the PO; or
transmit the RRC resume request message with a mobile terminal access (MT-Access) cause to the base station using a non-SDT preamble to initiate an RRC connected state of the UE after the PO when there is page for the UE to enable the UE to:
receive a page; and
receive downlink data associated with the page before the SDT procedure is initiated at the UE.

10. The apparatus of claim 9, wherein the one or more processors, coupled to the memory, are further configured to identify a plurality of fifth generation system temporary mobile subscriber identities (5G-S-TMSI) associated with the PO to enable the UE to determine when there is a matching 5G-S-TMSI of the plurality of 5G-S-TMSI in the PO that matches a 5G-S-TMSI of the UE to identify the page for the UE that is associated with the PO.

11. The apparatus of claim 10, wherein the one or more processors, coupled to the memory, are further configured to transmit the RRC resume request message to the base station using the SDT preamble when there is not the matching 5G-S-TMSI of the plurality of 5G-S-TMSI in the PO that matches the 5G-S-TMSI of the UE to determine that there is not the page associated with the UE to initiate the SDT procedure at the UE after the PO.

12. The apparatus of claim 10, wherein the one or more processors, coupled to the memory, are further configured to transmit the RRC resume request message with the MT-Access cause to the base station using the non-SDT preamble to initiate an RRC connected state of the UE after the PO when there is the matching 5G-S-TMSI of the plurality of 5G-S-TMSI in the PO that matches the 5G-S-TMSI of the UE.

13. The apparatus of claim 9, wherein the one or more processors, coupled to the memory, are further configured to:
identify uplink information in an uplink buffer at the UE that is ready to send using SDT;
determine, from the PEI, that a PO will be received from the UE; and
postpone sending the RRC resume request message in a UE assistance information (UAI) message to initiate the SDT procedure until after the PO is received at the UE.

14. A method of performing a mobile originated (MO) small data transfer (SDT) at a user equipment (UE) based on local information, the method comprising:
receiving a paging early indicator (PEI) at the UE, wherein the PEI is associated with a paging opportunity (PO) for the UE and the UE is a member of a subgroup of the PEI;
determining that there is uplink small data at the UE after receiving the PEI and prior to receiving the PO; and
determining to perform the MO SDT at the UE based on the local information at the UE.

15. The method of claim 14, wherein determining to perform the MO SDT at the UE based on the local information at the UE further comprises:
determining a screen status of the UE as one of a status of on or a status of off; and
sending the uplink small data using a non-SDT procedure when the screen status of the UE is screen on.

16. The method of claim 14, wherein determining to perform the MO SDT at the UE based on the local information at the UE further comprises:
determining a screen status of the UE as one of a status of on or a status of off; and
sending the uplink small data using an SDT procedure when the screen status of the UE is screen off.

17. The method of claim 14, wherein determining to perform the MO SDT at the UE based on the local information at the UE further comprises:
identifying one or more time sensitive applications is operating on the UE; and
sending the uplink small data using an SDT procedure when no time sensitive applications are actively operating on the UE.

18. The method of claim 17, wherein determining to perform the MO SDT at the UE based on the local information at the UE further comprises:
identifying one or more data throughput sensitive applications is operating on the UE; and
sending the uplink small data using an SDT procedure when no data throughput sensitive applications are actively operating on the UE.

19. The method of claim 18, further comprising sending the uplink small data using a non-SDT procedure when one or more of the time sensitive applications are operating on the UE or one or more of the data throughput sensitive applications are actively operating on the UE.

20. The method of claim 18, further comprising sending the uplink small data using the SDT procedure when no time sensitive applications are actively operating on the UE and no data throughput sensitive applications are actively operating on the UE.
